(19) United States
(12) Patent Application Publication
(10) Pub. No.: US 2026/0037765 A1
(43) Pub. Date: Feb. 5, 2026

(54) DUAL-BAND AND IN-BAND FREQUENCY SHIFT TECHNIQUES FOR BACKSCATTER COMMUNICATIONS

(71) Applicant: QUALCOMM Incorporated, San Diego, CA (US)

(72) Inventors: Piyush GUPTA, Bridgewater, NJ (US); Xiaoxia ZHANG, San Diego, CA (US); Junyi LI, Greentown, PA (US)

(21) Appl. No.: 18/792,213

(22) Filed: Aug. 1, 2024

(51) Int. Cl. G06K 19/07; H04B 7/22

(52) U.S. Cl. CPC G06K 19/0724; H04B 7/22

(57) ABSTRACT

Methods, systems, and devices for wireless communications are described. An ambient wireless device may receive, within a frequency band, first and second carrier waves separated by a frequency shift value. The frequency shift value may represent a frequency shift that enables the ambient wireless device to shift a backscattered signal from a downlink portion of a frequency band to an uplink portion of the frequency band. The ambient wireless device may perform a nonlinear operation to obtain a frequency shift carrier wave that is based on the frequency difference between the first carrier wave and the second carrier wave. The ambient wireless device may send a signal backscattered on a continuous wave received at the ambient wireless device, where the backscattered signal is sent at a frequency that is shifted, relative to a frequency at which the continuous wave is received, based on the frequency shift value.

### FIELD OF TECHNOLOGY

The following relates to wireless communications, including dual-band and in-band frequency shift techniques for backscatter communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a reader device is described. The method may include transmitting, to a wireless device, a first carrier wave at a first frequency within a first frequency band, transmitting, to the wireless device, a second carrier wave at a second frequency within the first frequency band, where the first frequency and the second frequency are separated by a frequency shift value, and receiving, from the wireless device, a signal backscattered on a continuous wave transmitted to the wireless device, where the backscattered signal is received at a frequency that is shifted, relative to a frequency at which the continuous wave is transmitted, based on the frequency shift value.

A reader device for wireless communications is described. The reader device may include one or more memories storing processor executable code, and one or more processors coupled with the one or more memories. The one or more processors may individually or collectively be operable to execute the code to cause the reader device to transmit, to a wireless device, a first carrier wave at a first frequency within a first frequency band, transmit, to the wireless device, a second carrier wave at a second frequency within the first frequency band, where the first frequency and the second frequency are separated by a frequency shift value, and receive, from the wireless device, a signal backscattered on a continuous wave transmitted to the wireless device, where the backscattered signal is received at a frequency that is shifted, relative to a frequency at which the continuous wave is transmitted, based on the frequency shift value.

Another reader device for wireless communications is described. The reader device may include means for transmitting, to a wireless device, a first carrier wave at a first frequency within a first frequency band, means for transmitting, to the wireless device, a second carrier wave at a second frequency within the first frequency band, where the first frequency and the second frequency are separated by a frequency shift value, and means for receiving, from the wireless device, a signal backscattered on a continuous wave transmitted to the wireless device, where the backscattered signal is received at a frequency that is shifted, relative to a frequency at which the continuous wave is transmitted, based on the frequency shift value.

A non-transitory computer-readable medium storing code for wireless communications is described. The code may include instructions executable by one or more processors to transmit, to a wireless device, a first carrier wave at a first frequency within a first frequency band, transmit, to the wireless device, a second carrier wave at a second frequency within the first frequency band, where the first frequency and the second frequency are separated by a frequency shift value, and receive, from the wireless device, a signal backscattered on a continuous wave transmitted to the wireless device, where the backscattered signal is received at a frequency that is shifted, relative to a frequency at which the continuous wave is transmitted, based on the frequency shift value.

In some examples of the method, reader devices, and non-transitory computer-readable medium described herein, the reader device may be configured with dual-band frequency shift capabilities and the method, apparatuses, and non-transitory computer-readable medium may include further operations, features, means, or instructions for transmitting the continuous wave in a downlink portion of a second frequency band that may be lower in frequency relative to the first frequency band and where receiving the backscattered signal includes receiving the backscattered signal in an uplink portion of the second frequency band that may be shifted, relative to the continuous wave in the downlink portion of the second frequency, by the frequency shift value.

In some examples of the method, reader devices, and non-transitory computer-readable medium described herein, the first frequency band may be 1800 MHz or 2100 MHz, the second frequency band may be 900 MHz, and the frequency shift value may be 45 MHz.

In some examples of the method, reader devices, and non-transitory computer-readable medium described herein, the first frequency band supports a bandwidth greater than the frequency shift value or the first frequency band may be an unlicensed frequency band.

In some examples of the method, reader devices, and non-transitory computer-readable medium described herein, and the method, apparatuses, and non-transitory computer-readable medium may include further operations, features, means, or instructions for where receiving the backscattered signal includes receiving the backscattered signal in an uplink portion of the first frequency band that may be shifted, relative to the continuous wave in the downlink portion of the first frequency band, by a multiple of a sum of the frequency shift value and a frequency of a local oscillator at the wireless device.

In some examples of the method, reader devices, and non-transitory computer-readable medium described herein, the first frequency band may be 900 MHz, the frequency shift value may be 13.08 MHz, and the frequency of the local oscillator at the wireless device may be 1.92 MHz.

Some examples of the method, reader devices, and non-transitory computer-readable medium described herein may further include operations, features, means, or instructions for receiving the backscattered signal includes receiving a third harmonic of a set of multiple harmonics of the backscattered signal in an uplink portion of the first frequency band that may be shifted, relative to the first carrier wave in the downlink portion of the first frequency band, by the multiple of the sum of the frequency shift value and the frequency of the local oscillator at the wireless device.

In some examples of the method, reader devices, and non-transitory computer-readable medium described herein, the continuous wave includes a multi-tone continuous wave.

In some examples of the method, reader devices, and non-transitory computer-readable medium described herein, the reader device includes a user equipment (UE) or a network entity.

A method for wireless communications by a wireless device is described. The method may include receiving a first carrier wave at a first frequency within a first frequency band, receiving a second carrier wave at a second frequency within the first frequency band, where the first frequency and the second frequency are separated by a frequency shift value, performing a nonlinear operation to obtain a frequency shift carrier wave that is based on a difference between the first frequency of the first carrier wave and the second frequency of the second carrier wave, and sending a signal backscattered on a continuous wave received at the wireless device, where the backscattered signal is sent at a frequency that is shifted, relative to a frequency at which the continuous wave is received, based on the frequency shift value.

A wireless device for wireless communications is described. The wireless device may include one or more memories storing processor executable code, and one or more processors coupled with the one or more memories. The one or more processors may individually or collectively be operable to execute the code to cause the wireless device to receive a first carrier wave at a first frequency within a first frequency band, receive a second carrier wave at a second frequency within the first frequency band, where the first frequency and the second frequency are separated by a frequency shift value, perform a nonlinear operation to obtain a frequency shift carrier wave that is based on a difference between the first frequency of the first carrier wave and the second frequency of the second carrier wave, and send a signal backscattered on a continuous wave received at the wireless device, where the backscattered signal is sent at a frequency that is shifted, relative to a frequency at which the continuous wave is received, based on the frequency shift value.

Another wireless device for wireless communications is described. The wireless device may include means for receiving a first carrier wave at a first frequency within a first frequency band, means for receiving a second carrier wave at a second frequency within the first frequency band, where the first frequency and the second frequency are separated by a frequency shift value, means for performing a nonlinear operation to obtain a frequency shift carrier wave that is based on a difference between the first frequency of the first carrier wave and the second frequency of the second carrier wave, and means for sending a signal backscattered on a continuous wave received at the wireless device, where the backscattered signal is sent at a frequency that is shifted, relative to a frequency at which the continuous wave is received, based on the frequency shift value.

A non-transitory computer-readable medium storing code for wireless communications is described. The code may include instructions executable by one or more processors to receive a first carrier wave at a first frequency within a first frequency band, receive a second carrier wave at a second frequency within the first frequency band, where the first frequency and the second frequency are separated by a frequency shift value, perform a nonlinear operation to obtain a frequency shift carrier wave that is based on a difference between the first frequency of the first carrier wave and the second frequency of the second carrier wave, and send a signal backscattered on a continuous wave received at the wireless device, where the backscattered signal is sent at a frequency that is shifted, relative to a frequency at which the continuous wave is received, based on the frequency shift value.

In some examples of the method, wireless devices, and non-transitory computer-readable medium described herein, the wireless device may be configured with dual-band frequency shift capabilities and the method, apparatuses, and non-transitory computer-readable medium may include further operations, features, means, or instructions for receiving the continuous wave in a downlink portion of a second frequency band that may be lower in frequency relative to the first frequency band and where sending the backscattered signal includes sending the backscattered signal in an uplink portion of the second frequency band that may be shifted, relative to the continuous wave in the downlink portion of the second frequency, by the frequency shift value.

In some examples of the method, wireless devices, and non-transitory computer-readable medium described herein, where the continuous wave may be received at a second receive antenna of a second receive chain of the wireless device, where the second receive antenna may be tuned to the second frequency band and where performing the nonlinear operation to obtain the frequency shift carrier wave includes performing the nonlinear operation using an envelope detector of the first receive chain.

Some examples of the method, wireless devices, and non-transitory computer-readable medium described herein may further include operations, features, means, or instructions for receiving, at a backscattering modulator of the wireless device, a square wave that may be output by the first receive chain at the frequency shift value, modulating, by the frequency shift value and data and at a backscattering antenna connected to the backscattering modulator, the continuous wave, generating, by the backscattering modulator, the backscattered signal as a product of the square wave and the modulated continuous wave, and where sending the backscattered signal includes sending, from the backscattering antenna, the backscattered signal.

Some examples of the method, wireless devices, and non-transitory computer-readable medium described herein may further include operations, features, means, or instructions for receiving, at the backscattering modulator, a second frequency shift carrier wave that may be output by a local oscillator at a second frequency shift value, where generating the backscattered signal may be based on the second frequency shift carrier wave and where sending the backscattered signal includes sending the backscattered signal at a frequency that may be shifted, relative to the frequency at which the continuous wave may be received, by a sum of the frequency shift value and the second frequency shift value.

In some examples of the method, wireless devices, and non-transitory computer-readable medium described herein, the first frequency band may be 1800 MHz or 2100 MHz, the second frequency band may be 900 MHz, and the frequency shift value may be 45 MHz.

In some examples of the method, wireless devices, and non-transitory computer-readable medium described herein, the first frequency band supports a bandwidth greater than the frequency shift value or the first frequency band may be an unlicensed frequency band.

In some examples of the method, wireless devices, and non-transitory computer-readable medium described herein, and the method, apparatuses, and non-transitory computer-readable medium may include further operations, features, means, or instructions for where sending the backscattered signal includes sending the backscattered signal in an uplink portion of the first frequency band that may be shifted, relative to the continuous wave in the downlink portion of the first frequency band, by a multiple of a sum of the frequency shift value and a frequency of a local oscillator.

In some examples of the method, wireless devices, and non-transitory computer-readable medium described herein, the first frequency band may be 900 MHz, and the frequency shift value may be 13.08 MHz, and the frequency of the local oscillator at the wireless device may be 1.92 MHz.

Some examples of the method, wireless devices, and non-transitory computer-readable medium described herein may further include operations, features, means, or instructions for sending the backscattered signal includes sending the backscattered signal in an uplink portion of the first frequency band that may be shifted, relative to the first carrier wave in the downlink portion of the first frequency band, by the multiple of the sum of the frequency shift value and the frequency of the local oscillator.

In some examples of the method, wireless devices, and non-transitory computer-readable medium described herein, the continuous wave includes a multi-tone continuous wave.

In some examples of the method, wireless devices, and non-transitory computer-readable medium described herein, the wireless device includes an Ambient Internet of Things (AIoT) device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dual-band and in-band frequency shift techniques for backscatter communications in accordance with one or more aspects of the present disclosure.

FIG. 2 shows an example of a portion of a wireless communications system that supports dual-band and in-band frequency shift techniques for backscatter communications in accordance with one or more aspects of the present disclosure.

FIG. 3 shows an example of ambient wireless device communications that support dual-band shift techniques for backscatter communications in accordance with one or more aspects of the present disclosure.

FIGS. 4A and 4B show examples of ambient wireless device communications that support in-band frequency shift techniques for backscatter communications in accordance with one or more aspects of the present disclosure.

FIG. 5 shows an example radio frequency receive chains of a wireless ambient device that supports dual-band and in-band frequency shift techniques for backscatter communications in accordance with one or more aspects of the present disclosure.

FIG. 6 shows an example of a process flow that supports dual-band and in-band frequency shift techniques for backscatter communications in accordance with one or more aspects of the present disclosure.

FIGS. 7 and 8 show block diagrams of devices that support dual-band and in-band frequency shift techniques for backscatter communications in accordance with one or more aspects of the present disclosure.

FIG. 9 shows a block diagram of a communications manager that supports dual-band and in-band frequency shift techniques for backscatter communications in accordance with one or more aspects of the present disclosure.

FIG. 10 shows a diagram of a system including a device that supports dual-band and in-band frequency shift techniques for backscatter communications in accordance with one or more aspects of the present disclosure.

FIGS. 11 through 16 show flowcharts illustrating methods that support dual-band and in-band frequency shift techniques for backscatter communications in accordance with one or more aspects of the present disclosure.

### DETAILED DESCRIPTION

Some wireless communications systems may include ambient wireless devices (e.g., Ambient Internet of Things (AIoT) devices, radio frequency identification (RFID)-capable devices, energy harvesting (EH)-capable wireless devices, or a combination thereof). A network entity may communicate with one or more ambient wireless devices via a reader device, such as a user equipment (UE) reader device or another reader device, where the one or more ambient wireless devices may be associated with a same cell (e.g., a same coverage area). The ambient wireless device may be a low-powered device, such as a tag (e.g., attached to a suitcase, keys, or a pet), and the reader device (or another device, e.g., a third device) may transmit a signal, such as a continuous wave (e.g., a waveform), to the ambient wireless device to activate or communicate with the ambient wireless device. The AIoT device may have minimal power and processing capabilities and may not be capable of generating a signal to send back to the reader device (e.g., the AIoT device may not have the components and circuitry of a radio frequency (RF) chain used for generating and communicating wireless signals). As such, an ambient wireless device may receive the continuous wave from the reader device, which may activate the ambient wireless device (e.g., activate one or more RF chains or components of the ambient device) to send a backscattered signal of the waveform modulated with data. For instance, the ambient wireless device may utilize the received continuous wave, such as to harvest or capture energy from the continuous wave, to modulate or reflect a signal to send back to the reader device (or to another device). In this case, the ambient wireless device may reflect and modulate (e.g., with data to be sent to the reader device) the received continuous wave to generate a signal that is backscattered on the continuous wave. The reader device that transmitted the continuous wave may receive and demodulate the backscattered signal to extract encoded data.

Because the reader device that transmits the waveform to activate the ambient wireless device may also receive the backscattered signal from the ambient wireless device, in some cases, the backscattered signal may be interfered with by the transmitting device's (e.g., the reader device's) own transmission, resulting in self-interference (or interference from the third device) at the transmitting device that receives the backscattered signal. As such, the ambient wireless device may shift a frequency of the backscattered signal relative to a frequency of the received continuous to reduce or cancel such interference. For instance, the ambient wireless device may generate a square wave that shifts the frequency from a first frequency (e.g., a frequency used to receive the continuous wave) to a second frequency (e.g., a frequency used to send the backscattered signal). In some cases, the frequency shift may be performed by a local oscillator at the ambient device and may be relatively small to keep the oscillator frequency low, which in turn may reduce (e.g., minimize) device and energy costs associated with the ambient wireless device. In some cases, because the frequency shift may be relatively small, if the continuous wave is received in the downlink band, the backscattered signal (e.g., an uplink signal), even when shifted, may also be in the same downlink band. When the ambient wireless is a type that performs amplification prior to backscattering, the backscattering with the amplification may cause interference at another nearby device, such as a nearby UE. On the other hand, if the continuous wave is received in the uplink band, the backscattered signal, even when shifted, may also be in the uplink band. In this case, because a transmission power constraint for the uplink band may be lower than a transmission power constraint associated with the downlink band, the transmission power of the continuous wave may be limited. In accordance with aspects described herein, to mitigate the interference or power constraint challenges associated with performing small frequency shifts at the ambient wireless device (e.g., interference challenges associated with the continuous wave in downlink or power constraint challenges associated with the continuous wave in uplink), the ambient wireless device may perform a relatively large frequency shift prior to backscattering with assistance from the reader device.

Aspects of the disclosure are initially described in the context of wireless communications systems. Aspects of the disclosure are further illustrated by and described with reference to apparatus diagrams, system diagrams, and flowcharts that relate to dual-band and in-band frequency shift techniques for backscatter communications.

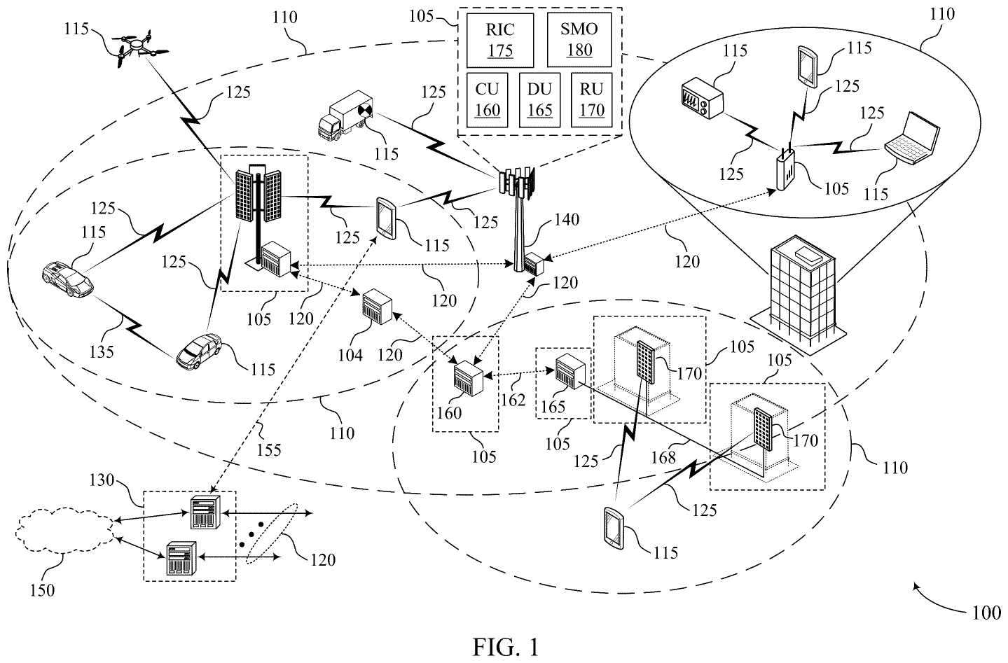

FIG. 1 shows an example of a wireless communications system 100 that supports dual-band and in-band frequency shift techniques for backscatter communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage arca 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100, a reader device, such as a network entity 105 or a UE 115, may assist an ambient wireless device, such as a UE 115, in reducing interference associated with backscatter communications. For instance, the reader device may assist the ambient wireless device in shifting a frequency of a backscatter signal, relative to a received continuous wave, by an amount that may cause interference associated with a backscatter signal from the ambient wireless device to be canceled or reduced. The reader device may send the ambient wireless device twin carrier waves (e.g., two waves) that are separated in frequency by an amount equal to a target frequency shift at the ambient wireless device. The ambient wireless device may receive the twin carrier waves and perform a non-linear cancellation procedure to extract a frequency shift carrier wave at the frequency shift amount based on the difference between the twin carrier waves (e.g., the frequency separation amount). The ambient wireless device may perform frequency shifted back scattering by using the extracted frequency shift carrier wave and the continuous wave. In some cases, the ambient wireless device may utilize a local oscillator to perform further frequency shifting for the back scattered signal.

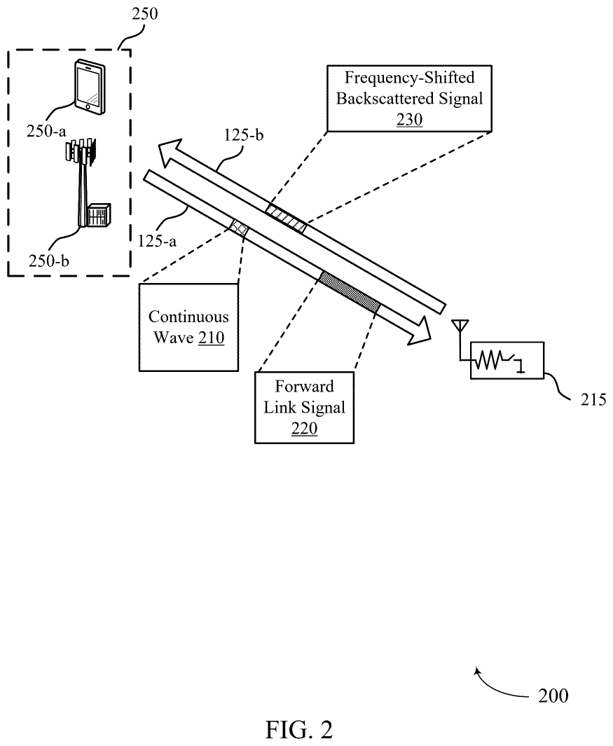

FIG. 2 shows an example of a portion of a wireless communications system 200 that supports dual-band and in-band frequency shift techniques for backscatter communications in accordance with one or more aspects of the present disclosure. The wireless communications system 200 may include a reader device 250 (e.g., UE reader device 250-a and base station reader device 250-b) and an ambient wireless device 215. The UE reader device 250-a and the ambient wireless device 215 may be examples of the UE 115, as described with reference to FIG. 1. The base station reader device 250-b may be an example of the network entity 105 or the base station 140, as described with reference to FIG. 1. The reader device 250 and the ambient wireless device 215 may communicate using communication links, such as communications links 125-a and 125-b. For example, communications link 125-a may be utilized for forward link and continuous wave transmissions from the reader device 250 to the ambient wireless device 215, and communications link 125-b may be utilized for backlink or backscattered communications from the ambient wireless device 215 to the reader device 250. The communications links 125-a and 125-b may be examples of communication link 125, as described with reference to FIG. 1.

The ambient wireless device 215 may be a low-power, low-complexity device (e.g., a tag, an AIoT device, an RFID-capable device, an EH-capable wireless device, or a combination thereof). The ambient wireless device 215 may have minimal circuitry and processing capabilities as compared with other user devices, such as the UE 115, and may be smaller and cheaper as compared to previous generations of IoT devices, such as narrow band (NB)-IoT, Long Term Machine Type Evolution (LTE-M), enhanced reduced capability (eRedCap) IoT devices. The ambient wireless device 215 may also have minimal energy storage capabilities and, in some cases, the primary energy source for the device may be from radio waves transmitted from a signal (e.g., a continuous wave or NR signal) from another device, such as from the reader device 250. In some cases, the ambient wireless device 215 may employ similar technologies as a passive UHF RFID. Accordingly, in some cases, due to the low-power, low-complexity capabilities and processing functionalities, the ambient wireless device 215 may not support some standard features or functionality as compared to other user or IoT devices. Additionally, different ambient wireless devices 215 may have different capabilities or support different functions. For instance, in some cases, the ambient wireless device 215 may be a first type of ambient wireless device 215 (e.g., a device type 1) or a second type of ambient wireless device 215 (e.g., a device type 2).

The first type of ambient wireless device 215 (e.g., device type 1) may be one of low complexity relative to the other ambient wireless devices 215. This type of device may have the capability to store limited amounts of energy, but may not be capable of independently generating a signal. Instead, the first type of ambient wireless device 215 may be an EH-capable device that utilizes back-scattering to transmit one or more signals based on a received signal (e.g., a continuous wave). For instance, the first type of ambient wireless device 215 may harvest energy received from continuous waves transmitted by a reader device 250. The first type of ambient wireless device 215 may utilize the harvested energy to perform back-scattering to send one or more signals back to the reader device 250 that transmitted the initial signal or to another device, such as by reflecting the received signal. These devices may have a peak power consumption of ˜1 μW and a range of <13 meters (m) to approximately 33 meters (m).

The second type of ambient wireless device 215 (e.g., device type 2) may have the capability to store greater amounts of energy relative to the first type of ambient wireless device 215. This type of device may be further categorized into various subtypes. For instance, a first subtype of the second type of ambient wireless device 215 (e.g., device type 2a) may be one of medium complexity relative to the other ambient wireless devices 215. This type of device may include energy storage, may have an initial sampling frequency offset (SFO) of up to 10× (e.g., 10 times) parts per million (ppm), and may communicate based on back-scattering on external carrier waves. For example, this type of wireless device may have neither downlink nor uplink amplification capabilities, and the device's uplink transmissions may be back-scattered on a carrier wave (e.g., a continuous wave) provided externally. Accordingly, a primary energy source for this type of device may be a received signal (e.g., a continuous wave) from the reader device 250. These devices may have a peak power consumption of approximately 10 to 100 μW and a range of approximately 22 m to 61 m.

A second subtype of the second type of ambient wireless device 215 (e.g., device type 2b) may be one of high complexity relative to the other types of ambient wireless devices 215. This type of device may include energy storage, may also have an initial SFO of up to 10× ppm, and may communicate based on internal generated carrier waves. This type of device may additionally have downlink or uplink amplification capabilities. Accordingly, the device's uplink transmissions may be generated independently by the device or may be back-scattered on a carrier wave provided externally. Accordingly, a primary energy source for this type of device may be a received signal (e.g., a continuous wave) from the reader device 250 or may be solar energy. These devices may have a peak power consumption of less than a few hundred μW and a range of approximately <100 m to 300 m.

The ambient wireless device 215 may include an oscillator which may be used to generate transmissions (e.g., backscattering or active transmissions) from the ambient wireless devices 215 to the reader device 250. For instance, the oscillator may be tuned, such that the transmissions are generated in a given frequency range. In some cases, the ambient wireless device 215 may perform backscatter communications with no frequency shifts. That is, the ambient wireless device 215 may receive an activation waveform, such as a continuous wave 210, at a first frequency, from the reader device 250. In some cases, the continuous wave 210 may be followed by a forward link signal 220 comprising a data message to be transmitted to the ambient wireless device 215. The continuous wave 210 may activate the ambient wireless device 215 and trigger the ambient wireless device 215 to send a response to the reader device 250 (e.g., a response to the forward link signal 220). In this case, the ambient wireless device 215 may send a signal that is backscattered on the continuous wave 210. The backscattered signal may be sent at the same frequency as the continuous wave 210 and, in some cases, may be modulated with a data message to be transmitted to the reader device 250.

In some cases, however, sending a backscattered signal at the same frequency as the continuous wave 210 may result in interference at the reader device 250. For instance, if the ambient wireless device 215 reflects the continuous wave 210, the reader device 250 may be unable to concurrently transmit the continuous wave 210 and efficiently decode the backscattered signal on a same frequency channel (e.g., due to self-interference). That is, the continuous wave 210 may interfere with one or more backscattered signals received by the reader device 250.

To reduce or minimize self-interference at the reader device 250, the ambient wireless device 215 may transmit a frequency-shifted backscattered signal 230. For instance, if the reader device 250 transmits the continuous wave 210 at a first frequency, the ambient wireless device 215 may use the continuous wave to generate a backscattered signal (e.g., modulated with a data message) at a second frequency that is shifted relative to the first frequency. As such, the reader device 250 may concurrently transmit the continuous wave 210 at the first frequency and receive the frequency-shifted backscattered signal 230 at the second frequency, thus reducing self-interference at the reader device.

In accordance with aspects described herein, the ambient wireless device 215 may perform frequency shifting with assistance from the reader device 250. In some cases, the ambient wireless device 215 may perform a relatively large in-band frequency shift. In other cases, such as when the reader device 250 supports dual-band operations, the ambient wireless device 215 may perform a relatively large frequency shift by utilizing both frequency bands. The relatively large frequency shift may enable the reader device 250 to transmit the continuous wave 210 in a downlink portion of the frequency band while receiving the frequency-shifted backscattered signal 230 in an uplink portion of the frequency band. By transmitting the continuous wave 210 in the downlink portion of the frequency band, the reader device 250 may transmit the continuous wave 210 at a transmission power level that is higher than a level used for transmitting in the uplink portion of the frequency band. Additionally, resource utilization may be improved based on the utilization of both the downlink and uplink portions of the frequency band and may mitigate performance of continuous wave interference cancellation at the reader device 250.

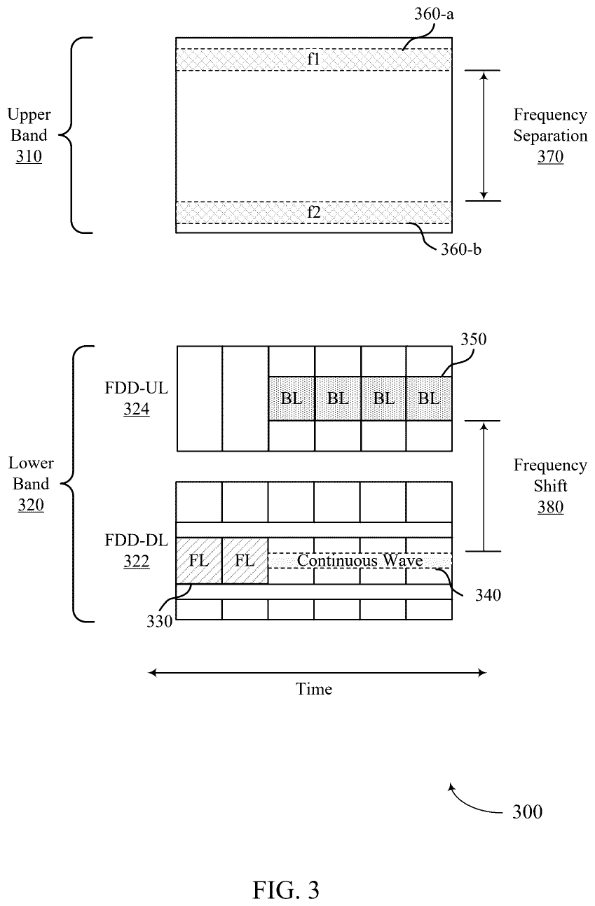

FIG. 3 shows an example of ambient wireless device communications 300 that support dual-band frequency shift techniques for backscatter communications in accordance with one or more aspects of the present disclosure. In some cases, the ambient wireless device communications 300 may support or be supported by aspects of the wireless communications systems 100 and 200, described with reference to FIGS. 1 and 2. For instance, the ambient wireless device communications 300 may be or include communications between the ambient wireless device 215 and the reader device 250 of FIG. 2.

In accordance with aspects described herein, prior to backscattering, the ambient wireless device 215 may perform a relatively large frequency shift with assistance from the reader device 250. In some implementations, the ambient wireless device 215 and the reader device 250 may support dual-band operations. In accordance with aspects described herein, in such instances, the reader device 250 may utilize a first frequency band, such as a lower band 320, for the ambient wireless device communications 300, and may utilize a second frequency band, such as an upper band 310 (e.g., a higher band), to provide one or more external carrier waves to the ambient wireless device 215 to assist the ambient wireless device 215 in performing the relatively large frequency shift. Utilizing the external carrier wave to assist in performing the relatively large frequency shift may enable the ambient wireless device 215 to avoid use of a local oscillator capable of operating at a relatively high frequency, thereby reducing both device and energy costs at the ambient wireless device 215.

The lower band 320 may be, for example, a 900 MHz frequency band, but might not be limited to the 900 MHz frequency band. The lower band 320 may utilize FDD, such that separate frequency bands may be allocated for downlink and uplink communications. For instance, an FDD-DL 322 portion of the lower band 320 may be allocated for downlink communications and an FDD-UL 324 portion of the lower band 320 may be allocated for uplink communications.

In some implementations, the FDD-DL 322 portion may be utilized for forward link communications 330 from the reader device 250 to the ambient wireless device 215. The FDD-DL 322 may additionally be utilized to transmit a continuous wave 340 from the reader device 250 to the ambient wireless device 215 to active the ambient wireless device 215.

Additionally, to mitigate interference at the reader device 250, in some instances, the ambient wireless device 215 may utilize the FDD-UL 324 portion of the lower band 320 for backward link communications 350 from the ambient wireless device 215 to the reader device 250. For instance, the ambient wireless device 215 may perform a relatively large frequency shift 380 from the continuous wave 340 transmitted in the FDD-DL 322 portion to the FDD-UL 324 portion of the lower band 320 in order to shift the backward link communications 350 (e.g., a signal backscatter-modulated on the continuous wave) to the FDD-UL 324 portion. In some cases, the ambient wireless device 215 may perform the relatively large frequency shift 380 from the FDD-DL 322 portion to the FDD-UL 324 with the assistance of one or more externally provided carrier waves, such as carrier waves transmitted from the reader device 250 in an available frequency band, such as the upper band 310.

The reader device 250 may utilize the upper band 310 to generate twin (e.g., two) carrier waves 360. For instance, the reader device 250 may generate a first carrier wave 360-a and a second carrier wave 360-b, and the first carrier wave 360-a and the second carrier wave 360-b may be separated by a frequency separation 370. In some cases, an amount of the frequency separation 370 may substantially correspond to an frequency amount that may enable a shift from the FDD-DL 322 portion to the FDD-UL 324 portion of the lower band 320 (e.g., the frequency shift 380). Accordingly, the reader device 250 may generate the twin carrier waves 360 in a frequency band that supports a bandwidth greater than or equal to the frequency shift 380 between the FDD-DL 322 portion and the FDD-UL 324 portion of the lower band 320. As an example, the frequency separation 370 may be 45 MHz, but might not be limited to 45 MHz. As a further example, the upper band 310 may be a 1800 MHz frequency band (e.g., n3 band) or a 2100 MHz (e.g., n1 band), but might not be limited to the 1800 MHz or 2100 MHz frequency bands. In some cases, the upper band 310 may be an unlicensed band, e.g., 2.4 GHz.

The reader device 250 may transmit the twin carrier waves 360 in the upper band 310, where the first carrier wave 360-a and the second carrier wave 360-b are separated by the frequency separation 370. The ambient wireless device 215 may receive the twin carrier waves 360 in the upper band 310 while additionally receiving the continuous wave 340 in the FDD-DL 322 portion of the lower band 320. The ambient wireless device 215 may perform a non-linear operation to extract or obtain a frequency shifted carrier wave based on a difference (e.g., the frequency separation 370) between the first carrier wave 360-a and the second carrier wave 360-b. Prior to backscattering, the ambient wireless device 215 may utilize the frequency shifted carrier wave and the continuous wave 340 to perform the frequency shift from the FDD-DL 322 portion to the FDD-UL 324 portion of the lower band 320 in order to shift the backscattered signal to the FDD-UL 324 portion of the lower band 320.

In some cases, the ambient wireless device 215 may utilize a local oscillator to perform an additional relatively small frequency shift. For instance, the additional relatively small frequency shift may be to support FDM backscattered communications from multiple ambient wireless devices on the backward link communications 350.

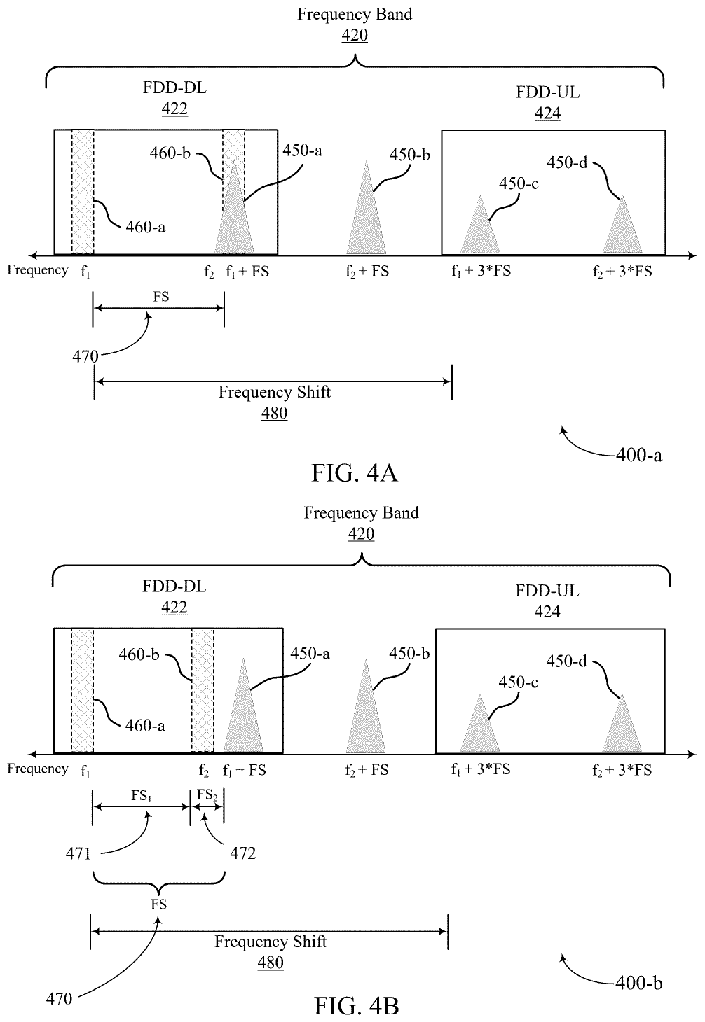

FIGS. 4A and 4B show examples of ambient wireless device communications 400-a and 400-b that support in-band frequency shift techniques for backscatter communications in accordance with one or more aspects of the present disclosure. In some cases, the ambient wireless device communications 400-a and 400-b may support or be supported by aspects of the wireless communications systems 100 and 200, described with reference to FIGS. 1 and 2. For instance, the ambient wireless device communications 400-a and 400-b may be or include communications between the ambient wireless device 215 and the reader device 250 of FIG. 2.

In accordance with aspects described herein, prior to backscattering, the ambient wireless device 215 may perform a relatively large frequency shift with assistance from the reader device 250. In some implementations, the ambient wireless device 215 and the reader device 250 may perform the relatively large frequency shift using an in-band approach (e.g., when the reader device 250 or the ambient wireless device 215 do not support dual-band operations). In accordance with aspects described herein, in such instances, the reader device 250 may utilize a single frequency band, such as frequency band 420, for both the ambient wireless device communications 400-a and 400-b and for providing one or more external carrier waves to the ambient wireless device 215 to assist the ambient wireless device 215 in performing the relatively large frequency shift.

The frequency band 420 may be, for example, a 900 MHz frequency band, but might not be limited to the 900 MHz frequency band. The frequency band 420 may utilize FDD, such that separate frequency bands may be allocated for downlink and uplink communications. For instance, an FDD-DL 422 portion of the frequency band 420 may be allocated for downlink communications and an FDD-UL 424 portion of the frequency band 420 may be allocated for uplink communications.

In some implementations, the reader device 250 may utilize the FDD-DL 422 portion to generate twin carrier waves 460. For instance, the reader device 250 may generate a first carrier wave 460-a and a second carrier wave 460-b, and the first carrier wave 460-a and the second carrier wave 460-b may be separated by a frequency separation 470. In some cases, the first carrier wave 460-a, the second carrier wave 460-b, or both may be utilized for forward link communications from the reader device 250 to the ambient wireless device 215 and, additionally, for transmission of a continuous wave from the reader device 250 to the ambient wireless device 215. In some cases, the continuous wave may be a multi-tone continuous wave of interest for frequency diversity.

To mitigate interference at the reader device 250, in some instances, the ambient wireless device 215 may utilize the FDD-UL 424 portion of the frequency band 420 for backward link communications, e.g., for a backscattered signal 450, from the ambient wireless device 215 to the reader device 250. For instance, the ambient wireless device 215 may perform a relatively large frequency shift 480 from the continuous wave transmitted in the FDD-DL 422 portion to the FDD-UL 424 portion of the frequency band 420 in order to shift the backscattered signal 450 to the FDD-UL 424 portion. In some cases, the ambient wireless device 215 may perform the relatively large frequency shift 480 from the FDD-DL 422 portion to the FDD-UL 424 based on performing a non-linear operation to extract or obtain a frequency shifted carrier wave that is based on a difference (e.g., the frequency separation 470) between the first carrier wave 460-a and the second carrier wave 460-b.

In some cases, because of limited bandwidth associated with use of a single frequency band for performing the large frequency shift (such as relative to the dual-band approach of FIG. 3) an amount of the frequency separation 470 may be less than a frequency amount that may enable a shift from the FDD-DL 422 portion to the FDD-UL 424 portion of the frequency band 420 (e.g., less than the frequency shift 480).

For instance, referring to FIG. 4A, in some cases, the frequency separation 470 may be a factor of the frequency shift 480. For example, in the case that the frequency shift 480 is 45 MHz (e.g., the frequency amount that may enable a shift from the FDD-DL 422 portion to the FDD-UL 424 portion), a factor of 3 may be used and the frequency separation 470, in this case, may be 15 MHz (e.g., 45 MHz/3=15 MHz). Accordingly, the twin carrier waves 460 separated by 15 MHz may be utilized by the ambient wireless device 215 to shift each harmonic of the backscattered signal 450 by a corresponding amount starting from the continuous wave. For instance, assuming the first carrier wave 460-a also acts as the continuous wave, the first harmonic 450-a of the backscattered signal 450 (e.g., corresponding to the first carrier wave 460-a) may be shifted from the first carrier wave 460-a by an amount corresponding to the frequency separation 470, e.g., shifted 15 MHz from the first carrier wave 460-a. A first harmonic 450-b of the second carrier wave 460-b may be shifted, relative to the second carrier wave 460-b, by an amount corresponding to the frequency separation 470, e.g., 15 MHz from the first harmonic 450-a. The third harmonic 450-c of the backscattered signal 450 (e.g., corresponding to the first carrier wave 460-a) may be shifted, relative to the first carrier wave 460-a, by an amount corresponding to the frequency shift 480, e.g., 45 MHz. Accordingly, the third harmonic 450-c of the backscattered signal 450 (e.g., corresponding to the first carrier wave 460-a) may be shifted by an amount (e.g., the frequency shift 480 (e.g., 3*15 MHz=45 MHz)) that enables the third harmonic 450-c and a third harmonic 450-d of the second carrier wave 460-b to be shifted to the FDD-UL 424 portion of the frequency band 420. As such, the reader device 250 may receive the third harmonic 450-c (e.g., corresponding to the first carrier wave 460-a) and the third harmonic 450-d (e.g., corresponding to the second carrier wave 460-b) in the FDD-UL 424 portion of the frequency band 420, which may provide frequency diversity.

In some implementations, use of the third harmonic 450-c may result in approximately a 9.5 dB loss as compared to the first harmonic 450-a, but may be compensated by improved pathloss relative to an upper band. Further, as shown in FIG. 4A, the first harmonic 450-a of the backscattered signal 450 may substantially overlap with the second carrier wave 460-b since the frequency separation from the first carrier wave 460-a is the same for both first harmonic 450-a and the second carrier wave 460-b. In some instances, such overlap may lead to a self-feedback loop.

Referring to FIG. 4B, to mitigate the self-feedback loop caused by an overlap of the first harmonic 450-a and the second carrier wave 460-b, the ambient wireless device 215 may utilize a local oscillator to create further separation between the first harmonic 450-a and the second carrier wave 460-b. For instance, the local oscillator may be similar to a local oscillator implemented at an RFID, for example having a relatively small frequency. For example, the local oscillator frequency 472 may be 1.92 MHz.

The ambient wireless device 215 may utilize a combination of the externally provided twin carrier waves 460 and the frequency generated by the local oscillator (e.g., the local oscillator frequency 472) to perform the frequency shift 480. In this way, a frequency separation, e.g., a carrier wave frequency separation 471, between the first carrier wave 460-a and the second carrier wave 460-b of the twin carrier waves 460 may be reduced (e.g., relative to the FIG. 4A example), such that the combination of the carrier wave frequency separation 471 and the local oscillator frequency 472 may correspond to a frequency separation 470 that is a factor of the frequency shift 480. For example, the carrier wave frequency separation 471 may be 13.08 MHz when the local oscillator frequency 472 is 1.92 MHz, such that the combination corresponds to a frequency separation 470 of 15 MHz, and the frequency separation 470 of 15 MHz may be a factor of the frequency shift 480 of 45 MHz. Further, the higher the frequency of the local oscillator the further the separation between the twin carrier waves 460 may be reduced.

Accordingly, in the FIG. 4B example, the ambient wireless device 215 may utilize the twin carrier waves 460 separated by 13.08 MHz together with the frequency generated by the local oscillator at 1.92 MHz to shift each harmonic of the backscattered signal 450 by a corresponding combined amount starting from the continuous wave. For instance, assuming the first carrier wave 460-a also acts as the continuous wave, the first harmonic 450-a of the backscattered signal 450 (e.g., corresponding to the first carrier wave 460-a) may be shifted from the first carrier wave 460-a by an amount corresponding to the frequency separation 470, such as the sum of the carrier wave frequency separation 471 and the local oscillator frequency 472 (e.g., 13.08 MHz+1.92 MHz=15 MHz). In this way, the first harmonic 450-a may not overlap with the second carrier wave 460-b. A first harmonic 450-b of the second carrier wave 460-b may be shifted, relative to the second carrier wave 460-b, by an amount corresponding to the frequency separation 470. The third harmonic 450-c of the backscattered signal 450 (e.g., corresponding to the first carrier wave 460-a) may be shifted, relative to the first carrier wave 460-a, by an amount corresponding to the frequency shift 480. Accordingly, the third harmonic 450-c of the backscattered signal 450 (e.g., corresponding to the first carrier wave 460-a) may be shifted by an amount that enables the third harmonic 450-c and a third harmonic 450-d of the second carrier wave 460-b to be shifted to the FDD-UL 424 portion of the frequency band 420. As such, the reader device 250 may receive the third harmonic 450-c (e.g., corresponding to the first carrier wave 460-a) and the third harmonic 450-d (e.g., corresponding to the second carrier wave 460-b) in the FDD-UL 424 portion of the frequency band 420, which may provide frequency diversity.

In some cases, the ambient wireless device 215 may further utilize the local oscillator to perform an additional relatively small frequency shift. For instance, the additional relatively small frequency shift may be to support FDM backscattered communications from multiple ambient wireless devices on the backward link communications 350.

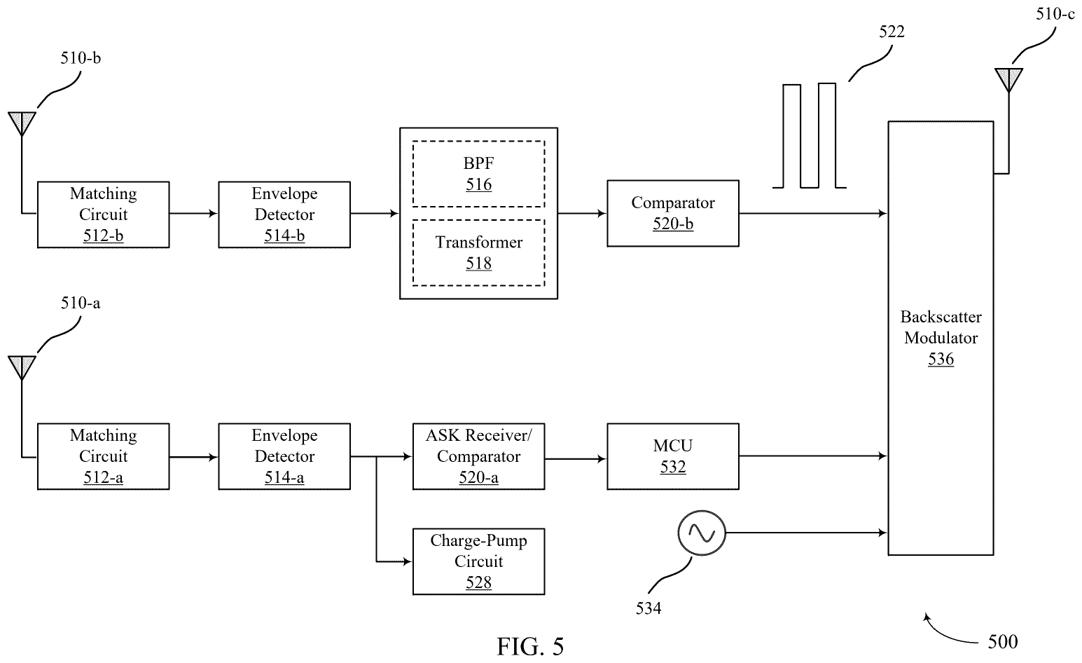

FIG. 5 shows an example of RF receive chains 500 of a wireless ambient device that supports dual-band and in-band frequency shift techniques for backscatter communications in accordance with one or more aspects of the present disclosure. In some cases, the RF receive chains 500 may support or be supported by aspects of the wireless communications systems 100 and 200, described with reference to FIGS. 1 and 2. For instance, the RF receive chains 500 implemented at the ambient wireless device 215 of FIG. 2.

In some implementations, the ambient wireless device 215 may be implemented with two receive chains, such as a lower receive chain and an upper receive chain. The lower receive chain may be tuned to a frequency associated with an FDD-DL portion of a frequency band (such as the FDD-DL 322 portion of the lower band 320 or the FDD-DL 422 portion of the frequency band 420, as described with reference to FIGS. 3, 4A, and 4B). The lower receive chain may be configured for forward link (e.g., receiving a query or other command from the reader device 250.). The lower receive chain may include a lower receive antenna 510-a for receiving the forward link signal. The lower receive antenna 510-a may be connected to a matching circuit 512-a, which may be followed an envelope detector 514-a, followed by a change-pump circuit 528 and an ASK receiver/comparator 520-a, which may be fed to an microcontroller unit (MCU) 532. The MCU 532 may in turn be fed to a backscattering modulator 536. Based on forward link information transmitted from the reader device 250, the ambient wireless device 215 may determine data to be modulated and backscattered onto the continuous wave and sent back to the reader device 250. The backscattering modulator 536 may backscatter the continuous wave with a modulated signal including the determined data and may output the modulated backscattered continuous wave via a backscattering antenna 510-c connected to the backscattering modulator 536.

In some implementation, such as when the ambient wireless device 215 supports dual-band operations (e.g., operates in a dual-band mode), the upper receive chain may be tuned to a frequency associated with an upper band, such as the upper band 310 described with reference to FIG. 3. In some implementations, such as when the ambient wireless device 215 does not support or does not operate in a dual-band mode, the upper receive chain may be tuned to a frequency associated with an FDD-DL portion of the single frequency band used by the ambient wireless device 215 (such as the FDD-DL 422 portion of the frequency band 420, described with respect to FIGS. 4A and 4B).

The upper receive chain may be configured for receiving the externally provided twin carrier waves from the reader device 250, such as the twin carrier waves 360 separated by the frequency separation 370, or the twin carrier waves 460 separated by the frequency separation 470, as described with reference to FIGS. 3, 4A, and 4B. The upper receive chain may include an upper receive antenna 510-b for receiving the twin carrier waves 360 or 460. The upper receive antenna 510-b may be connected to a matching circuit 512-b, which may be followed an envelope detector 514-b. The envelope detector 514-b may be used to perform the non-linear operation described with respect to FIGS. 3, 4A, and 4B to extract a frequency shift carrier wave from the twin carrier waves 360 or 460 based on the associated frequency separation 370 or 470. The envelope detector 514-b may be followed by a bandpass filter (BPF) 516 or a transformer 518, which may be tuned to a frequency associated with the frequency separation 370 (e.g., 45 MHz), the frequency separation 470 (e.g., 15 MHz), or the carrier wave frequency separation 471 (e.g., 13.08 MHz), described with reference to FIGS. 3, 4A, and 4B. The BPF 516 or the transformer 518 may be followed by a comparator 520-b configured to generate a square wave 522. The square wave 522 may be fed to the backscattering modulator 536 which may generate a product of the square wave and the continuous wave, resulting in a backscattered signal that is shifted by the frequency separation 370 (e.g., the relatively large frequency shift).

In some cases, a local oscillator 534 may be connected to the backscattering modulator 536 for performing relatively small frequency shifts, such as to further separate a first harmonic of a backscattered signal, e.g., the first harmonic 450-a, from a second carrier wave 460-b, as described with reference to FIGS. 4A and 4B, or additionally, or alternatively, to support FDM backscattered communications from multiple ambient wireless devices.

In some cases, various components of the upper and lower receive chains may be time-shared. For instance, the backscattering antenna 510-c may be the same as the lower receive antenna 510-a (since they may both be tuned to the FDD-DL band), the envelope detectors 514-a and 514-b may be a shared envelope detector, or the comparators 520-a and 520-b may be a shared comparator. Such time-sharing of components may be supported since the upper and lower receive chains operate in half-duplex mode. That is, the ambient wireless device 215 may either be receiving a forward link, in which case, the lower receive chain may be active or may be backscattering, in which case, this upper receive chain may be active, but in such cases both receive chains might not be active at the same time.

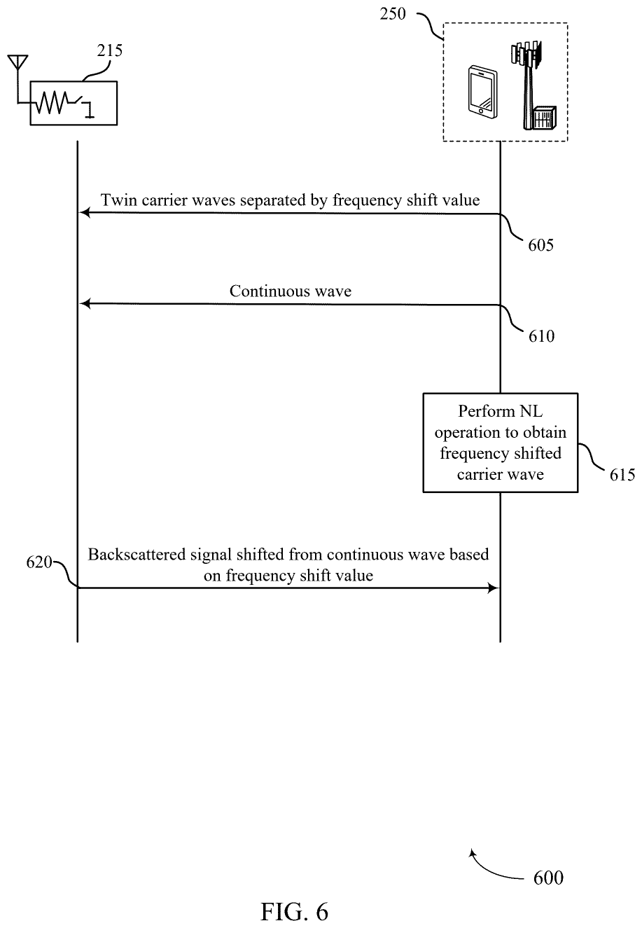

FIG. 6 shows an example of a process flow 600 that supports dual-band and in-band frequency shift techniques for backscatter communications in accordance with one or more aspects of the present disclosure. In some examples, process flow 600 may implement or be implemented by aspects of wireless communications system 100 and 200, ambient wireless device communications 300, 400-a, and 400-b, or RF receive chains 500 described with reference to FIGS. 1, 2, 3, 4A, and 4B. For instance, process flow 600 may be implemented by the reader device 250 and ambient wireless device 215, as described with reference to FIGS. 1, 2, 3, 4A, and 4B. Alternative examples of the following may be implemented, where some steps are performed in a different order than described, or are not performed at all. In some cases, steps may include additional features not mentioned below, or further steps may be added. In addition, while process flow 600 shows processes between a reader device 250 and one ambient wireless devices 215, it should be understood that these processes may occur between any quantity of ambient wireless devices.

At 605, the reader device 250 may transmit, and the ambient wireless device 215 may receive, a twin carrier waves. In some implementations, such as where the reader device 250 and the ambient wireless device 215 support dual-band operations or operate in a dual-band mode, the twin carrier waves may be transmitted and received in a first frequency band of a plurality of frequency bands in which the reader device 250 and the ambient wireless device 215 are configured to operate. For instance, the reader device 250 and the ambient wireless device 215 may be configured to operate in both an upper and a lower frequency band, and the twin carrier waves may be transmitted and received in the upper frequency band that is not otherwise utilized for ambient wireless device communications. In some implementations, such as where the reader device 250 and the ambient wireless device 215 do not support dual-band operations or do not operate in a dual-band mode, the twin carrier waves may be transmitted and received in a downlink portion of an available frequency band used by the reader device 250 and the ambient wireless device 215 for ambient wireless device communications. The twin carrier waves may comprise a first carrier wave and a second carrier wave that are separated in frequency by a frequency shift value.

At 610, the reader device 250 may transmit, and the ambient wireless device 215 may receive, a continuous wave (e.g., used to activate the ambient wireless device 215). In some cases, the twin carrier waves and the continuous wave may be transmitted or received concurrently. The continuous wave may be transmitted and received in a downlink portion of a frequency band used by the reader device 250 and the ambient wireless device 215 for ambient wireless device communications. In some cases, the continuous wave may be followed by forward link communications from the reader device 250 and the ambient wireless device 215.

At 615, the ambient wireless device 215 may perform a non-linear operation based on the separation between the first and second carrier waves of the twin carrier waves to extract or obtain a frequency shift carrier wave. The ambient wireless device 215 may generate a square wave based on the frequency shift carrier wave. Based on a product of the square wave and the continuous wave, the ambient wireless device 215 may generate a modulated backscattered signal that is shifted in frequency, relative to the continuous wave, by the frequency shift value. In some implementations, the ambient wireless device 215, may utilize a frequency generated by a local oscillator together with the frequency shift carrier wave and the continuous wave to generate the shifted modulated backscattered signal. In some implementations, the shifted modulated backscattered signal may be shifted in frequency, relative to the continuous wave, by a multiple of the frequency shift value. In some implementations, the local oscillator may be utilized to perform additional relatively small positive or negative frequency shifts of the modulated backscattered signal.

At 620, the reader receive 250 may receive the modulated backscattered signal that is shifted, relative to the continuous wave, by an amount that is based on the frequency shift value (e.g., based on the frequency separation of the externally provided twin carrier waves) and, in some cases, further based on a small frequency shift provided by a local oscillator. The modulated backscattered signal may be shifted such that it is received in an uplink portion of the frequency band used for ambient wireless device communications.

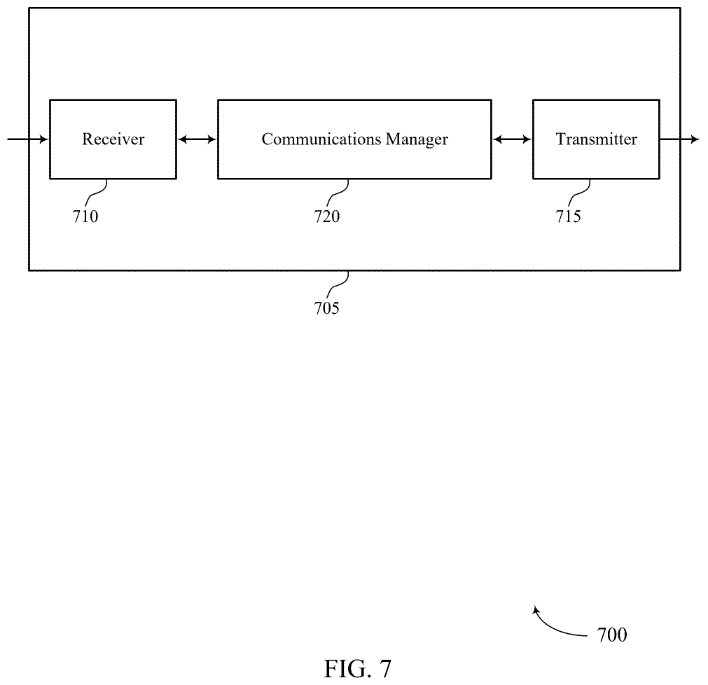

FIG. 7 shows a block diagram 700 of a device 705 that supports dual-band and in-band frequency shift techniques for backscatter communications in accordance with one or more aspects of the present disclosure. The device 705 may be an example of aspects of an ambient wireless device 215 or a reader device 250 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dual-band and in-band frequency shift techniques for backscatter communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dual-band and in-band frequency shift techniques for backscatter communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of dual-band and in-band frequency shift techniques for backscatter communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting, to a wireless device, a first carrier wave at a first frequency within a first frequency band. The communications manager 720 is capable of, configured to, or operable to support a means for transmitting, to the wireless device, a second carrier wave at a second frequency within the first frequency band, where the first frequency and the second frequency are separated by a frequency shift value. The communications manager 720 is capable of, configured to, or operable to support a means for receiving, from the wireless device, a signal backscattered on a continuous wave transmitted to the wireless device, where the backscattered signal is received at a frequency that is shifted, relative to a frequency at which the continuous wave is transmitted, based on the frequency shift value.

Additionally, or alternatively, the communications manager 720 may support wireless communications in accordance with examples as disclosed herein. For example, the communications manager 720 is capable of, configured to, or operable to support a means for receiving a first carrier wave at a first frequency within a first frequency band. The communications manager 720 is capable of, configured to, or operable to support a means for receiving a second carrier wave at a second frequency within the first frequency band, where the first frequency and the second frequency are separated by a frequency shift value. The communications manager 720 is capable of, configured to, or operable to support a means for performing a nonlinear operation to obtain a frequency shift carrier wave that is based on a difference between the first frequency of the first carrier wave and the second frequency of the second carrier wave. The communications manager 720 is capable of, configured to, or operable to support a means for sending a signal backscattered on a continuous wave received at the wireless device, where the backscattered signal is sent at a frequency that is shifted, relative to a frequency at which the continuous wave is received, based on the frequency shift value.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and more efficient utilization of communication resources.

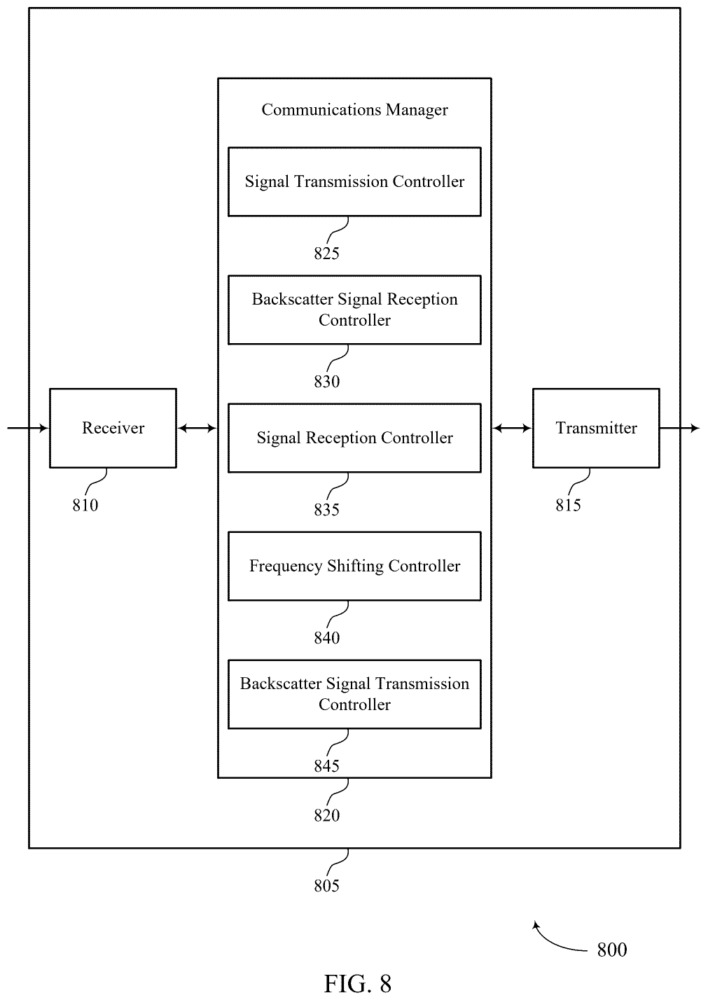

FIG. 8 shows a block diagram 800 of a device 805 that supports dual-band and in-band frequency shift techniques for backscatter communications in accordance with one or more aspects of the present disclosure. The device 805 may be an example of aspects of a device 705, an ambient wireless device 215, or a reader device 250 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to dual-band and in-band frequency shift techniques for backscatter communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dual-band and in-band frequency shift techniques for backscatter communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of dual-band and in-band frequency shift techniques for backscatter communications as described herein. For example, the communications manager 820 may include a signal transmission controller 825, a backscatter signal reception controller 830, a signal reception controller 835, a frequency shifting controller 840, a backscatter signal transmission controller 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The signal transmission controller 825 is capable of, configured to, or operable to support a means for transmitting, to a wireless device, a first carrier wave at a first frequency within a first frequency band. The signal transmission controller 825 is capable of, configured to, or operable to support a means for transmitting, to the wireless device, a second carrier wave at a second frequency within the first frequency band, where the first frequency and the second frequency are separated by a frequency shift value. The backscatter signal reception controller 830 is capable of, configured to, or operable to support a means for receiving, from the wireless device, a signal backscattered on a continuous wave transmitted to the wireless device, where the backscattered signal is received at a frequency that is shifted, relative to a frequency at which the continuous wave is transmitted, based on the frequency shift value.

Additionally, or alternatively, the communications manager 820 may support wireless communications in accordance with examples as disclosed herein. The signal reception controller 835 is capable of, configured to, or operable to support a means for receiving a first carrier wave at a first frequency within a first frequency band. The signal reception controller 835 is capable of, configured to, or operable to support a means for receiving a second carrier wave at a second frequency within the first frequency band, where the first frequency and the second frequency are separated by a frequency shift value. The frequency shifting controller 840 is capable of, configured to, or operable to support a means for performing a nonlinear operation to obtain a frequency shift carrier wave that is based on a difference between the first frequency of the first carrier wave and the second frequency of the second carrier wave. The backscatter signal transmission controller 845 is capable of, configured to, or operable to support a means for sending a signal backscattered on a continuous wave received at the wireless device, where the backscattered signal is sent at a frequency that is shifted, relative to a frequency at which the continuous wave is received, based on the frequency shift value.

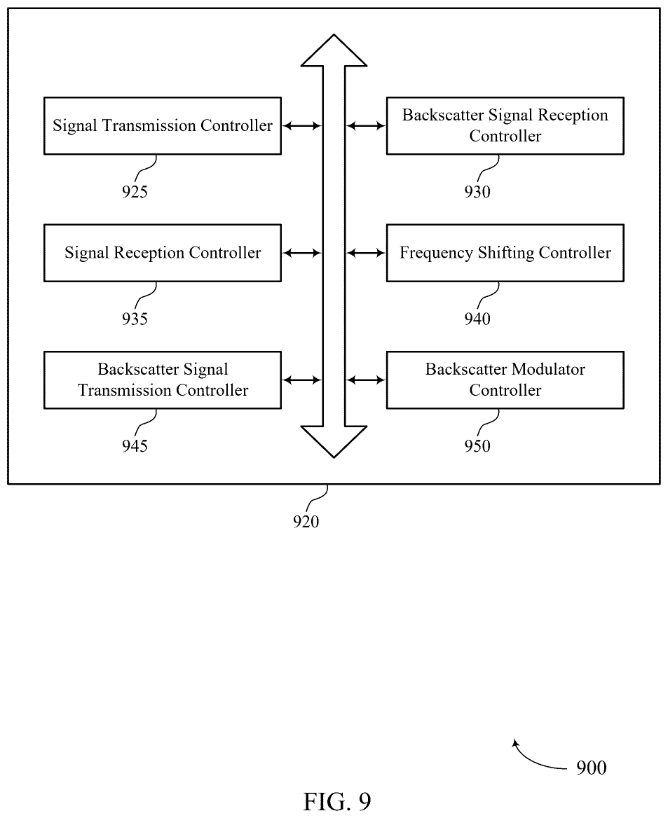

FIG. 9 shows a block diagram 900 of a communications manager 920 that supports dual-band and in-band frequency shift techniques for backscatter communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of dual-band and in-band frequency shift techniques for backscatter communications as described herein. For example, the communications manager 920 may include a signal transmission controller 925, a backscatter signal reception controller 930, a signal reception controller 935, a frequency shifting controller 940, a backscatter signal transmission controller 945, a backscatter modulator controller 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The signal transmission controller 925 is capable of, configured to, or operable to support a means for transmitting, to a wireless device, a first carrier wave at a first frequency within a first frequency band. In some examples, the signal transmission controller 925 is capable of, configured to, or operable to support a means for transmitting, to the wireless device, a second carrier wave at a second frequency within the first frequency band, where the first frequency and the second frequency are separated by a frequency shift value. The backscatter signal reception controller 930 is capable of, configured to, or operable to support a means for receiving, from the wireless device, a signal backscattered on a continuous wave transmitted to the wireless device, where the backscattered signal is received at a frequency that is shifted, relative to a frequency at which the continuous wave is transmitted, based on the frequency shift value.

In some examples, the reader device is configured with dual-band frequency shift capabilities, and the signal transmission controller 925 is capable of, configured to, or operable to support a means for transmitting the continuous wave in a downlink portion of a second frequency band that is lower in frequency relative to the first frequency band. In some examples, the reader device is configured with dual-band frequency shift capabilities, and the backscatter signal reception controller 930 is capable of, configured to, or operable to support a means for receiving the backscattered signal in an uplink portion of the second frequency band that is shifted, relative to the continuous wave in the downlink portion of the second frequency, by the frequency shift value.

In some examples, the first frequency band is 1800 MHz or 2100 MHz, the second frequency band is 900 MHz, and the frequency shift value is 45 MHz.

In some examples, the first frequency band supports a bandwidth greater than the frequency shift value or the first frequency band is an unlicensed frequency band.

In some examples, the reader device is configured with in-band frequency shift capabilities. In some examples, the first carrier wave or the second carrier wave includes the continuous wave. In some examples, the continuous wave is transmitted in a downlink portion of the first frequency band. In some examples, to support a means for receiving the backscattered signal the backscatter signal reception controller 930 is capable of, configured to, or operable to support a means for receiving the backscattered signal in an uplink portion of the first frequency band that is shifted, relative to the continuous wave in the downlink portion of the first frequency band, by a multiple of a sum of the frequency shift value and a frequency of a local oscillator at the wireless device.

In some examples, the first frequency band is 900 MHz, the frequency shift value is 13.08 MHz, and the frequency of the local oscillator at the wireless device is 1.92 MHz.

In some examples, receiving the backscattered signal includes receiving a third harmonic of a set of multiple harmonics of the backscattered signal in an uplink portion of the first frequency band that is shifted, relative to the first carrier wave in the downlink portion of the first frequency band, by the multiple of the sum of the frequency shift value and the frequency of the local oscillator at the wireless device.

In some examples, the continuous wave includes a multi-tone continuous wave.

In some examples, the reader device includes a UE or a network entity.

Additionally, or alternatively, the communications manager 920 may support wireless communications in accordance with examples as disclosed herein. The signal reception controller 935 is capable of, configured to, or operable to support a means for receiving a first carrier wave at a first frequency within a first frequency band. In some examples, the signal reception controller 935 is capable of, configured to, or operable to support a means for receiving a second carrier wave at a second frequency within the first frequency band, where the first frequency and the second frequency are separated by a frequency shift value. The frequency shifting controller 940 is capable of, configured to, or operable to support a means for performing a nonlinear operation to obtain a frequency shift carrier wave that is based on a difference between the first frequency of the first carrier wave and the second frequency of the second carrier wave. The backscatter signal transmission controller 945 is capable of, configured to, or operable to support a means for sending a signal backscattered on a continuous wave received at the wireless device, where the backscattered signal is sent at a frequency that is shifted, relative to a frequency at which the continuous wave is received, based on the frequency shift value.

In some examples, the wireless device is configured with dual-band frequency shift capabilities, and the signal reception controller 935 is capable of, configured to, or operable to support a means for receiving the continuous wave in a downlink portion of a second frequency band that is lower in frequency relative to the first frequency band. In some examples, the wireless device is configured with dual-band frequency shift capabilities, and the backscatter signal transmission controller 945 is capable of, configured to, or operable to support a means for sending the backscattered signal in an uplink portion of the second frequency band that is shifted, relative to the continuous wave in the downlink portion of the second frequency, by the frequency shift value.

In some examples, where the continuous wave is received at a second receive antenna of a second receive chain of the wireless device, where the second receive antenna is tuned to the second frequency band. In some examples, where performing the nonlinear operation to obtain the frequency shift carrier wave includes performing the nonlinear operation using an envelope detector of the first receive chain.

In some examples, the backscatter modulator controller 950 is capable of, configured to, or operable to support a means for receiving, at a backscattering modulator of the wireless device, a square wave that is output by the first receive chain at the frequency shift value. In some examples, the backscatter modulator controller 950 is capable of, configured to, or operable to support a means for modulating, by the frequency shift value and data and at a backscattering antenna connected to the backscattering modulator, the continuous wave. In some examples, the backscatter signal transmission controller 945 is capable of, configured to, or operable to support a means for generating, by the backscattering modulator, the backscattered signal as a product of the square wave and the modulated continuous wave. In some examples, the 955 is capable of, configured to, or operable to support a means for sending, from the backscattering antenna, the backscattered signal.

In some examples, the backscatter modulator controller 950 is capable of, configured to, or operable to support a means for receiving, at the backscattering modulator, a second frequency shift carrier wave that is output by a local oscillator at a second frequency shift value, where generating the backscattered signal is based on the second frequency shift carrier wave. In some examples, the backscatter signal transmission controller 945 is capable of, configured to, or operable to support a means for sending the backscattered signal at a frequency that is shifted, relative to the frequency at which the continuous wave is received, by a sum of the frequency shift value and the second frequency shift value.

In some examples, the first frequency band is 1800 MHz or 2100 MHz, the second frequency band is 900 MHz, and the frequency shift value is 45 MHz.

In some examples, the first frequency band supports a bandwidth greater than the frequency shift value or the first frequency band is an unlicensed frequency band.

In some examples, the wireless device is configured with in-band frequency shift capabilities. In some examples, the first carrier wave or the second carrier wave includes the continuous wave. In some examples, the continuous wave is transmitted in a downlink portion of the first frequency band. In some examples, to support sending the backscattered signal, the backscatter signal transmission controller 945 is capable of, configured to, or operable to support a means for sending the backscattered signal in an uplink portion of the first frequency band that is shifted, relative to the continuous wave in the downlink portion of the first frequency band, by a multiple of a sum of the frequency shift value and a frequency of a local oscillator.

In some examples, the first frequency band is 900 MHz, and the frequency shift value is 13.08 MHz, and the frequency of the local oscillator at the wireless device is 1.92 MHz.

In some examples, sending the backscattered signal includes sending the backscattered signal in an uplink portion of the first frequency band that is shifted, relative to the first carrier wave in the downlink portion of the first frequency band, by the multiple of the sum of the frequency shift value and the frequency of the local oscillator.

In some examples, the continuous wave includes a multi-tone continuous wave.

In some examples, the wireless device includes an Ambient Internet of Things (AIoT) device.

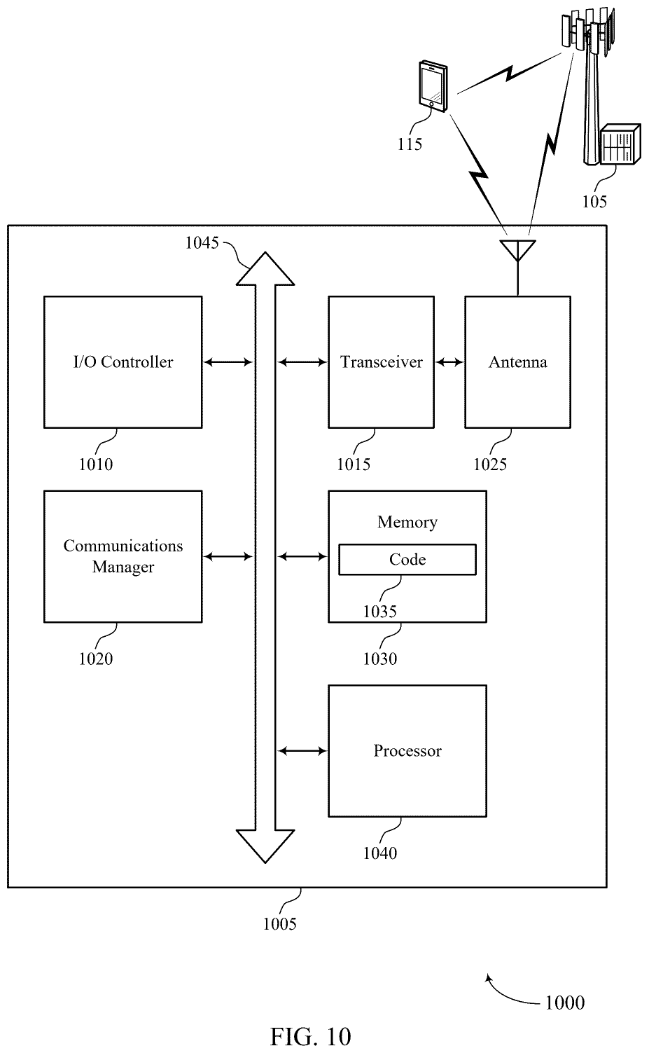

FIG. 10 shows a diagram of a system 1000 including a device 1005 that supports dual-band and in-band frequency shift techniques for backscatter communications in accordance with one or more aspects of the present disclosure. The device 1005 may be an example of or include components of a device 705, a device 805, an ambient wireless device 215, or a reader device 250, as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting dual-band and in-band frequency shift techniques for backscatter communications). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting, to a wireless device, a first carrier wave at a first frequency within a first frequency band. The communications manager 1020 is capable of, configured to, or operable to support a means for transmitting, to the wireless device, a second carrier wave at a second frequency within the first frequency band, where the first frequency and the second frequency are separated by a frequency shift value. The communications manager 1020 is capable of, configured to, or operable to support a means for receiving, from the wireless device, a signal backscattered on a continuous wave transmitted to the wireless device, where the backscattered signal is received at a frequency that is shifted, relative to a frequency at which the continuous wave is transmitted, based on the frequency shift value.

Additionally, or alternatively, the communications manager 1020 may support wireless communications in accordance with examples as disclosed herein. For example, the communications manager 1020 is capable of, configured to, or operable to support a means for receiving a first carrier wave at a first frequency within a first frequency band. The communications manager 1020 is capable of, configured to, or operable to support a means for receiving a second carrier wave at a second frequency within the first frequency band, where the first frequency and the second frequency are separated by a frequency shift value. The communications manager 1020 is capable of, configured to, or operable to support a means for performing a nonlinear operation to obtain a frequency shift carrier wave that is based on a difference between the first frequency of the first carrier wave and the second frequency of the second carrier wave. The communications manager 1020 is capable of, configured to, or operable to support a means for sending a signal backscattered on a continuous wave received at the wireless device, where the backscattered signal is sent at a frequency that is shifted, relative to a frequency at which the continuous wave is received, based on the frequency shift value.

By including or configuring the communications manager 1020 in accordance with examples as described herein, the device 1005 may support techniques for improved communication reliability, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of dual-band and in-band frequency shift techniques for backscatter communications as described herein, or the at least one processor 1040 and the at least one memory 1030 may be otherwise configured to, individually or collectively, perform or support such operations.

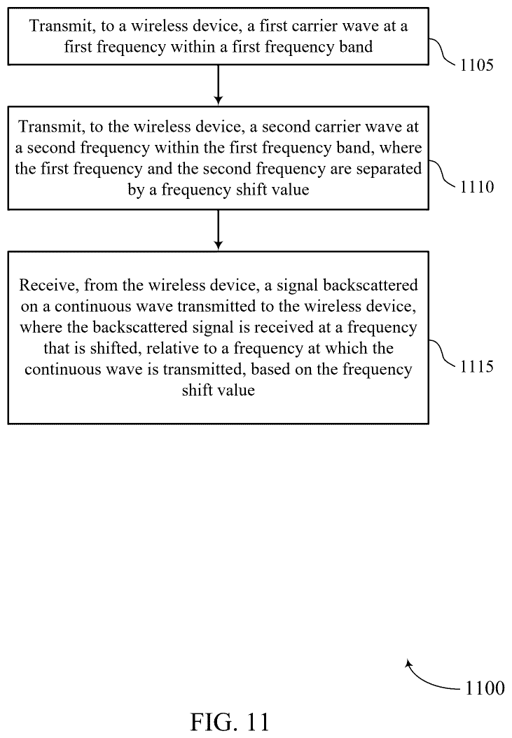

FIG. 11 shows a flowchart illustrating a method 1100 that supports dual-band and in-band frequency shift techniques for backscatter communications in accordance with one or more aspects of the present disclosure. The operations of the method 1100 may be implemented by a UE or a network entity or their components as described herein. For example, the operations of the method 1100 may be performed by an ambient wireless device 215 or a reader device 250 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include transmitting, to a wireless device, a first carrier wave at a first frequency within a first frequency band. The operations of 1105 may be performed in accordance with examples as disclosed herein. In some examples, aspects of the operations of 1105 may be performed by a signal transmission controller 925 as described with reference to FIG. 9.

At 1110, the method may include transmitting, to the wireless device, a second carrier wave at a second frequency within the first frequency band, where the first frequency and the second frequency are separated by a frequency shift value. The operations of 1110 may be performed in accordance with examples as disclosed herein. In some examples, aspects of the operations of 1110 may be performed by a signal transmission controller 925 as described with reference to FIG. 9.

At 1115, the method may include receiving, from the wireless device, a signal backscattered on a continuous wave transmitted to the wireless device, where the backscattered signal is received at a frequency that is shifted, relative to a frequency at which the continuous wave is transmitted, based on the frequency shift value. The operations of 1115 may be performed in accordance with examples as disclosed herein. In some examples, aspects of the operations of 1115 may be performed by a backscatter signal reception controller 930 as described with reference to FIG. 9.

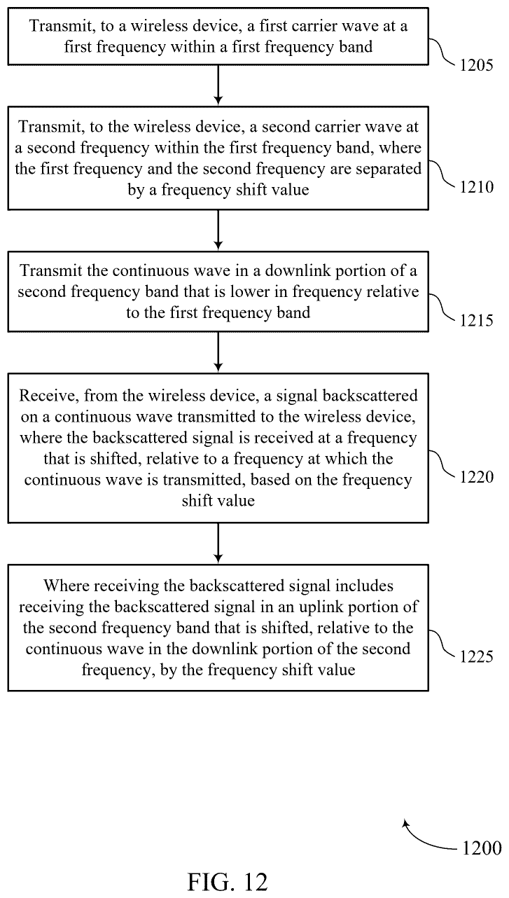

FIG. 12 shows a flowchart illustrating a method 1200 that supports dual-band and in-band frequency shift techniques for backscatter communications in accordance with one or more aspects of the present disclosure. The operations of the method 1200 may be implemented by a UE or a network entity or their components as described herein. For example, the operations of the method 1200 may be performed by an ambient wireless device 215 or a reader device 250 as described with reference to FIGS. 1 through 10. In some examples, a UE or network entity may execute a set of instructions to control the functional elements of the UE or the network entity to perform the described functions. Additionally, or alternatively, the UE or the network entity may perform aspects of the described functions using special-purpose hardware.

At 1205, the method may include transmitting, to a wireless device, a first carrier wave at a first frequency within a first frequency band. The operations of 1205 may be performed in accordance with examples as disclosed herein. In some examples, aspects of the operations of 1205 may be performed by a signal transmission controller 925 as described with reference to FIG. 9.

At 1210, the method may include transmitting, to the wireless device, a second carrier wave at a second frequency within the first frequency band, where the first frequency and the second frequency are separated by a frequency shift value. The operations of 1210 may be performed in accordance with examples as disclosed herein. In some examples, aspects of the operations of 1210 may be performed by a signal transmission controller 925 as described with reference to FIG. 9.

At 1215, the method may include transmitting the continuous wave in a downlink portion of a second frequency band that is lower in frequency relative to the first frequency band. The operations of 1215 may be performed in accordance with examples as disclosed herein. In some examples, aspects of the operations of 1215 may be performed by a signal transmission controller 925 as described with reference to FIG. 9.

At 1220, the method may include receiving, from the wireless device, a signal backscattered on a continuous wave transmitted to the wireless device, where the backscattered signal is received at a frequency that is shifted, relative to a frequency at which the continuous wave is transmitted, based on the frequency shift value. The operations of 1220 may be performed in accordance with examples as disclosed herein. In some examples, aspects of the operations of 1220 may be performed by a backscatter signal reception controller 930 as described with reference to FIG. 9.

At 1225, the method may include where receiving the backscattered signal includes receiving the backscattered signal in an uplink portion of the second frequency band that is shifted, relative to the continuous wave in the downlink portion of the second frequency, by the frequency shift value. The operations of 1225 may be performed in accordance with examples as disclosed herein. In some examples, aspects of the operations of 1225 may be performed by a backscatter signal reception controller 930 as described with reference to FIG. 9.

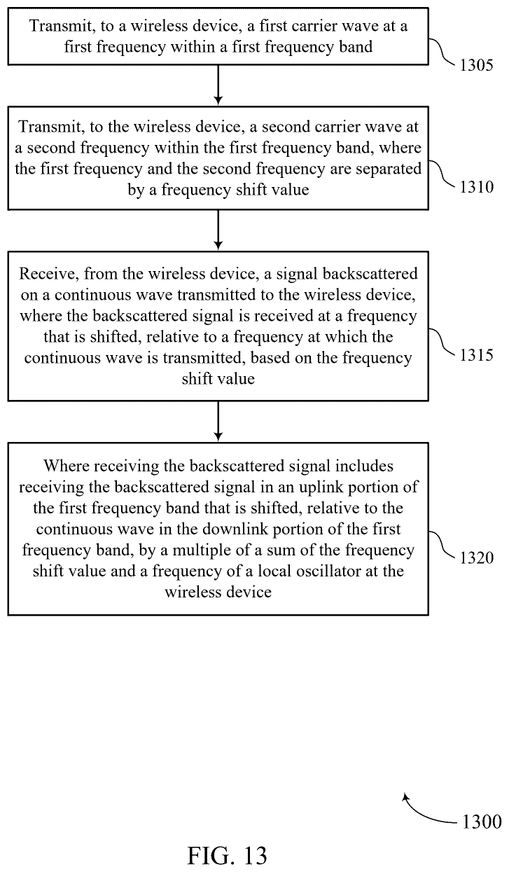

FIG. 13 shows a flowchart illustrating a method 1300 that supports dual-band and in-band frequency shift techniques for backscatter communications in accordance with one or more aspects of the present disclosure. The operations of the method 1300 may be implemented by a UE or a network entity or their components as described herein. For example, the operations of the method 1300 may be performed by an ambient wireless device 215 or a reader device 250 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include transmitting, to a wireless device, a first carrier wave at a first frequency within a first frequency band. The operations of 1305 may be performed in accordance with examples as disclosed herein. In some examples, aspects of the operations of 1305 may be performed by a signal transmission controller 925 as described with reference to FIG. 9.

At 1310, the method may include transmitting, to the wireless device, a second carrier wave at a second frequency within the first frequency band, where the first frequency and the second frequency are separated by a frequency shift value. The operations of 1310 may be performed in accordance with examples as disclosed herein. In some examples, aspects of the operations of 1310 may be performed by a signal transmission controller 925 as described with reference to FIG. 9.

At 1315, the method may include receiving, from the wireless device, a signal backscattered on a continuous wave transmitted to the wireless device, where the backscattered signal is received at a frequency that is shifted, relative to a frequency at which the continuous wave is transmitted, based on the frequency shift value. The operations of 1315 may be performed in accordance with examples as disclosed herein. In some examples, aspects of the operations of 1315 may be performed by a backscatter signal reception controller 930 as described with reference to FIG. 9.

At 1320, the method may include where receiving the backscattered signal includes receiving the backscattered signal in an uplink portion of the first frequency band that is shifted, relative to the continuous wave in the downlink portion of the first frequency band, by a multiple of a sum of the frequency shift value and a frequency of a local oscillator at the wireless device. The operations of 1320 may be performed in accordance with examples as disclosed herein. In some examples, aspects of the operations of 1320 may be performed by a backscatter signal reception controller 930 as described with reference to FIG. 9.

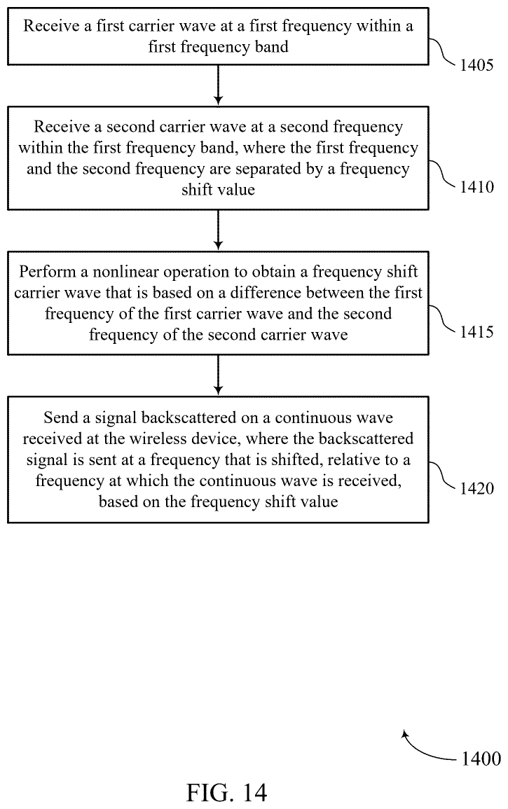

FIG. 14 shows a flowchart illustrating a method 1400 that supports dual-band and in-band frequency shift techniques for backscatter communications in accordance with one or more aspects of the present disclosure. The operations of the method 1400 may be implemented by a UE or a network entity or their components as described herein. For example, the operations of the method 1400 may be performed by an ambient wireless device 215 or a reader device 250 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include receiving a first carrier wave at a first frequency within a first frequency band. The operations of 1405 may be performed in accordance with examples as disclosed herein. In some examples, aspects of the operations of 1405 may be performed by a signal reception controller 935 as described with reference to FIG. 9.

At 1410, the method may include receiving a second carrier wave at a second frequency within the first frequency band, where the first frequency and the second frequency are separated by a frequency shift value. The operations of 1410 may be performed in accordance with examples as disclosed herein. In some examples, aspects of the operations of 1410 may be performed by a signal reception controller 935 as described with reference to FIG. 9.

At 1415, the method may include performing a nonlinear operation to obtain a frequency shift carrier wave that is based on a difference between the first frequency of the first carrier wave and the second frequency of the second carrier wave. The operations of 1415 may be performed in accordance with examples as disclosed herein. In some examples, aspects of the operations of 1415 may be performed by a frequency shifting controller 940 as described with reference to FIG. 9.

At 1420, the method may include sending a signal backscattered on a continuous wave received at the wireless device, where the backscattered signal is sent at a frequency that is shifted, relative to a frequency at which the continuous wave is received, based on the frequency shift value. The operations of 1420 may be performed in accordance with examples as disclosed herein. In some examples, aspects of the operations of 1420 may be performed by a backscatter signal transmission controller 945 as described with reference to FIG. 9.

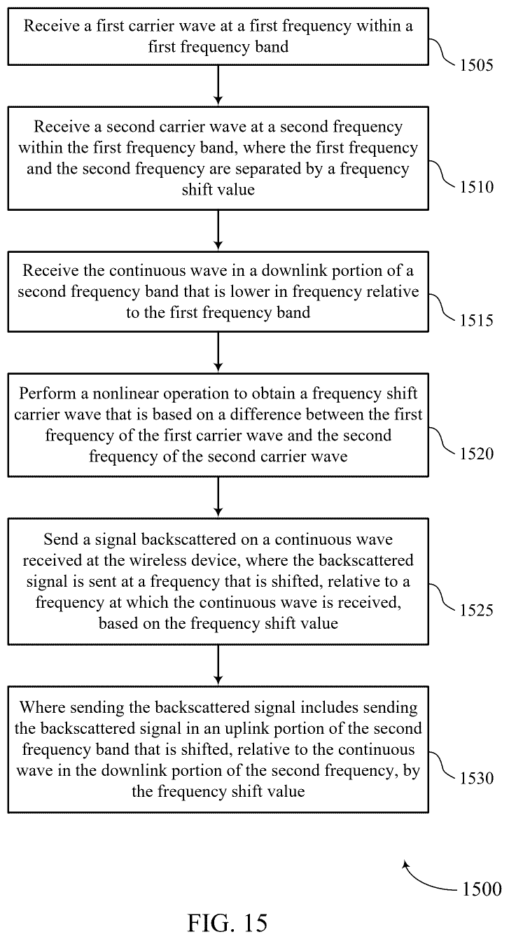

FIG. 15 shows a flowchart illustrating a method 1500 that supports dual-band and in-band frequency shift techniques for backscatter communications in accordance with one or more aspects of the present disclosure. The operations of the method 1500 may be implemented by a UE or a network entity or their components as described herein. For example, the operations of the method 1500 may be performed by an ambient wireless device 215 or a reader device 250 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include receiving a first carrier wave at a first frequency within a first frequency band. The operations of 1505 may be performed in accordance with examples as disclosed herein. In some examples, aspects of the operations of 1505 may be performed by a signal reception controller 935 as described with reference to FIG. 9.

At 1510, the method may include receiving a second carrier wave at a second frequency within the first frequency band, where the first frequency and the second frequency are separated by a frequency shift value. The operations of 1510 may be performed in accordance with examples as disclosed herein. In some examples, aspects of the operations of 1510 may be performed by a signal reception controller 935 as described with reference to FIG. 9.

At 1515, the method may include receiving the continuous wave in a downlink portion of a second frequency band that is lower in frequency relative to the first frequency band. The operations of 1515 may be performed in accordance with examples as disclosed herein. In some examples, aspects of the operations of 1515 may be performed by a signal reception controller 935 as described with reference to FIG. 9.

At 1520, the method may include performing a nonlinear operation to obtain a frequency shift carrier wave that is based on a difference between the first frequency of the first carrier wave and the second frequency of the second carrier wave. The operations of 1520 may be performed in accordance with examples as disclosed herein. In some examples, aspects of the operations of 1520 may be performed by a frequency shifting controller 940 as described with reference to FIG. 9.

At 1525, the method may include sending a signal backscattered on a continuous wave received at the wireless device, where the backscattered signal is sent at a frequency that is shifted, relative to a frequency at which the continuous wave is received, based on the frequency shift value. The operations of 1525 may be performed in accordance with examples as disclosed herein. In some examples, aspects of the operations of 1525 may be performed by a backscatter signal transmission controller 945 as described with reference to FIG. 9.

At 1530, the method may include where sending the backscattered signal includes sending the backscattered signal in an uplink portion of the second frequency band that is shifted, relative to the continuous wave in the downlink portion of the second frequency, by the frequency shift value. The operations of 1530 may be performed in accordance with examples as disclosed herein. In some examples, aspects of the operations of 1530 may be performed by a backscatter signal transmission controller 945 as described with reference to FIG. 9.

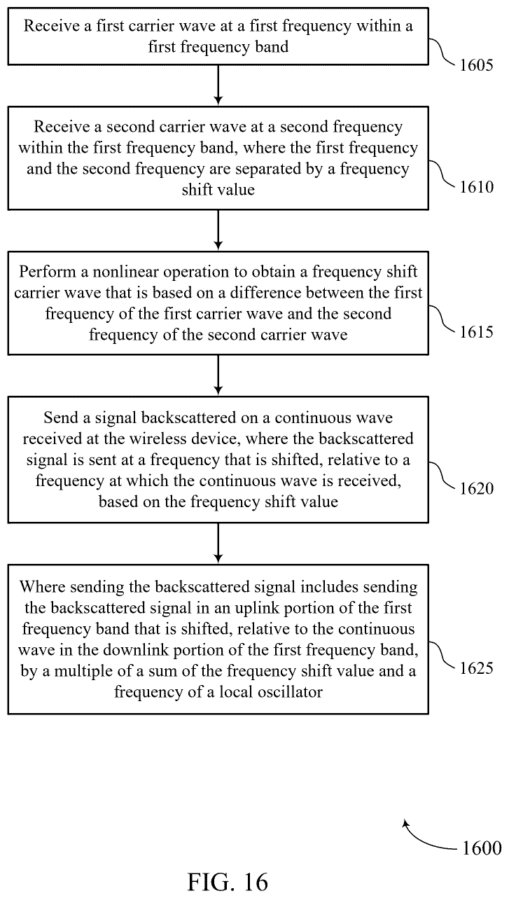

FIG. 16 shows a flowchart illustrating a method 1600 that supports dual-band and in-band frequency shift techniques for backscatter communications in accordance with one or more aspects of the present disclosure. The operations of the method 1600 may be implemented by a UE or a network entity or their components as described herein. For example, the operations of the method 1600 may be performed by an ambient wireless device 215 or a reader device 250 as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving a first carrier wave at a first frequency within a first frequency band. The operations of 1605 may be performed in accordance with examples as disclosed herein. In some examples, aspects of the operations of 1605 may be performed by a signal reception controller 935 as described with reference to FIG. 9.

At 1610, the method may include receiving a second carrier wave at a second frequency within the first frequency band, where the first frequency and the second frequency are separated by a frequency shift value. The operations of 1610 may be performed in accordance with examples as disclosed herein. In some examples, aspects of the operations of 1610 may be performed by a signal reception controller 935 as described with reference to FIG. 9.

At 1615, the method may include performing a nonlinear operation to obtain a frequency shift carrier wave that is based on a difference between the first frequency of the first carrier wave and the second frequency of the second carrier wave. The operations of 1615 may be performed in accordance with examples as disclosed herein. In some examples, aspects of the operations of 1615 may be performed by a frequency shifting controller 940 as described with reference to FIG. 9.

At 1620, the method may include sending a signal backscattered on a continuous wave received at the wireless device, where the backscattered signal is sent at a frequency that is shifted, relative to a frequency at which the continuous wave is received, based on the frequency shift value. The operations of 1620 may be performed in accordance with examples as disclosed herein. In some examples, aspects of the operations of 1620 may be performed by a backscatter signal transmission controller 945 as described with reference to FIG. 9.

At 1625, the method may include where sending the backscattered signal includes sending the backscattered signal in an uplink portion of the first frequency band that is shifted, relative to the continuous wave in the downlink portion of the first frequency band, by a multiple of a sum of the frequency shift value and a frequency of a local oscillator. The operations of 1625 may be performed in accordance with examples as disclosed herein. In some examples, aspects of the operations of 1625 may be performed by a backscatter signal transmission controller 945 as described with reference to FIG. 9.

The following provides an overview of aspects of the present disclosure:
Aspect 1: A method for wireless communications by a reader device, comprising: transmitting, to a wireless device, a first carrier wave at a first frequency within a first frequency band; transmitting, to the wireless device, a second carrier wave at a second frequency within the first frequency band, wherein the first frequency and the second frequency are separated by a frequency shift value; and receiving, from the wireless device, a signal backscattered on a continuous wave transmitted to the wireless device, wherein the backscattered signal is received at a frequency that is shifted, relative to a frequency at which the continuous wave is transmitted, based at least in part on the frequency shift value.
Aspect 2: The method of aspect 1, wherein the reader device is configured with dual-band frequency shift capabilities, wherein the method further comprises: transmitting the continuous wave in a downlink portion of a second frequency band that is lower in frequency relative to the first frequency band, and wherein receiving the backscattered signal comprises receiving the backscattered signal in an uplink portion of the second frequency band that is shifted, relative to the continuous wave in the downlink portion of the second frequency, by the frequency shift value.
Aspect 3: The method of aspect 2, wherein the first frequency band is 1800 MHz or 2100 MHz, the second frequency band is 900 MHz, and the frequency shift value is 45 MHz.
Aspect 4: The method of any of aspects 1 through 3, wherein the first frequency band supports a bandwidth greater than the frequency shift value or the first frequency band is an unlicensed frequency band.
Aspect 5: The method of any of aspects 1 through 4, wherein the reader device is configured with in-band frequency shift capabilities, wherein the first carrier wave or the second carrier wave comprises the continuous wave, wherein the continuous wave is transmitted in a downlink portion of the first frequency band, and wherein receiving the backscattered signal comprises receiving the backscattered signal in an uplink portion of the first frequency band that is shifted, relative to the continuous wave in the downlink portion of the first frequency band, by a multiple of a sum of the frequency shift value and a frequency of a local oscillator at the wireless device.
Aspect 6: The method of aspect 5, wherein the first frequency band is 900 MHz, the frequency shift value is 13.08 MHz, and the frequency of the local oscillator at the wireless device is 1.92 MHz.
Aspect 7: The method of any of aspects 1 through 6, wherein receiving the backscattered signal comprises receiving a third harmonic of a plurality of harmonics of the backscattered signal in an uplink portion of the first frequency band that is shifted, relative to the first carrier wave in the downlink portion of the first frequency band, by the multiple of the sum of the frequency shift value and the frequency of the local oscillator at the wireless device.
Aspect 8: The method of any of aspects 1 through 7, wherein the continuous wave comprises a multi-tone continuous wave.
Aspect 9: The method of any of aspects 1 through 8, wherein the reader device comprises a UE or a network entity.
Aspect 10: A method for wireless communications by a wireless device, comprising: receiving a first carrier wave at a first frequency within a first frequency band; receiving a second carrier wave at a second frequency within the first frequency band, wherein the first frequency and the second frequency are separated by a frequency shift value; performing a nonlinear operation to obtain a frequency shift carrier wave that is based at least in part on a difference between the first frequency of the first carrier wave and the second frequency of the second carrier wave; and sending a signal backscattered on a continuous wave received at the wireless device, wherein the backscattered signal is sent at a frequency that is shifted, relative to a frequency at which the continuous wave is received, based at least in part on the frequency shift value.
Aspect 11: The method of aspect 10, wherein the wireless device is configured with dual-band frequency shift capabilities, wherein the method further comprises: receiving the continuous wave in a downlink portion of a second frequency band that is lower in frequency relative to the first frequency band, and wherein sending the backscattered signal comprises sending the backscattered signal in an uplink portion of the second frequency band that is shifted, relative to the continuous wave in the downlink portion of the second frequency, by the frequency shift value.
Aspect 12: The method of aspect 11, wherein the first carrier wave and the second carrier wave are received at a first receive antenna of a first receive chain of the wireless device, wherein the first receive antenna is tuned to the first frequency band, wherein the continuous wave is received at a second receive antenna of a second receive chain of the wireless device, wherein the second receive antenna is tuned to the second frequency band, and wherein performing the nonlinear operation to obtain the frequency shift carrier wave comprises performing the nonlinear operation using an envelope detector of the first receive chain.
Aspect 13: The method of aspect 12, further comprising: receiving, at a backscattering modulator of the wireless device, a square wave that is output by the first receive chain at the frequency shift value; modulating, by the frequency shift value and data and at a backscattering antenna connected to the backscattering modulator, the continuous wave; and generating, by the backscattering modulator, the backscattered signal as a product of the square wave and the modulated continuous wave, wherein sending the backscattered signal comprises sending, from the backscattering antenna, the backscattered signal.
Aspect 14: The method of aspect 13, further comprising: receiving, at the backscattering modulator, a second frequency shift carrier wave that is output by a local oscillator at a second frequency shift value, wherein generating the backscattered signal is based at least in part on the second frequency shift carrier wave, and wherein sending the backscattered signal comprises sending the backscattered signal at a frequency that is shifted, relative to the frequency at which the continuous wave is received, by a sum of the frequency shift value and the second frequency shift value.
Aspect 15: The method of any of aspects 11 through 14, wherein the first frequency band is 1800 MHz or 2100 MHz, the second frequency band is 900 MHz, and the frequency shift value is 45 MHz.
Aspect 16: The method of any of aspects 10 through 15, wherein the first frequency band supports a bandwidth greater than the frequency shift value or the first frequency band is an unlicensed frequency band.
Aspect 17: The method of any of aspects 10 through 16, wherein the wireless device is configured with in-band frequency shift capabilities, wherein the first carrier wave or the second carrier wave comprises the continuous wave, wherein the continuous wave is transmitted in a downlink portion of the first frequency band, and wherein sending the backscattered signal comprises sending the backscattered signal in an uplink portion of the first frequency band that is shifted, relative to the continuous wave in the downlink portion of the first frequency band, by a multiple of a sum of the frequency shift value and a frequency of a local oscillator.
Aspect 18: The method of aspect 17, wherein the first frequency band is 900 MHz, and the frequency shift value is 13.08 MHz, and the frequency of the local oscillator at the wireless device is 1.92 MHz.
Aspect 19: The method of any of aspects 10 through 18, wherein sending the backscattered signal comprises sending the backscattered signal in an uplink portion of the first frequency band that is shifted, relative to the first carrier wave in the downlink portion of the first frequency band, by the multiple of the sum of the frequency shift value and the frequency of the local oscillator.
Aspect 20: The method of any of aspects 10 through 19, wherein the continuous wave comprises a multi-tone continuous wave.
Aspect 21: The method of any of aspects 10 through 20, wherein the wireless device comprises an Ambient Internet of Things (AIoT) device.
Aspect 22: A reader device for wireless communications, comprising one or more memories storing processor-executable code, and one or more processors coupled with the one or more memories and individually or collectively operable to execute the code to cause the reader device to perform a method of any of aspects 1 through 9.
Aspect 23: A reader device for wireless communications, comprising at least one means for performing a method of any of aspects 1 through 9.
Aspect 24: A non-transitory computer-readable medium storing code for wireless communications, the code comprising instructions executable by one or more processors to perform a method of any of aspects 1 through 9.
Aspect 25: A wireless device for wireless communications, comprising one or more memories storing processor-executable code, and one or more processors coupled with the one or more memories and individually or collectively operable to execute the code to cause the wireless device to perform a method of any of aspects 10 through 21.
Aspect 26: A wireless device for wireless communications, comprising at least one means for performing a method of any of aspects 10 through 21.
Aspect 27: A non-transitory computer-readable medium storing code for wireless communications, the code comprising instructions executable by one or more processors to perform a method of any of aspects 10 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A reader device, comprising:
one or more memories storing processor-executable code; and
one or more processors coupled with the one or more memories and individually or collectively operable to execute the code to cause the reader device to:
transmit, to a wireless device, a first carrier wave at a first frequency within a first frequency band;
transmit, to the wireless device, a second carrier wave at a second frequency within the first frequency band, wherein the first frequency and the second frequency are separated by a frequency shift value; and
receive, from the wireless device, a signal backscattered on a continuous wave transmitted to the wireless device, wherein the backscattered signal is received at a frequency that is shifted, relative to a frequency at which the continuous wave is transmitted, based at least in part on the frequency shift value.

2. The reader device of claim 1, wherein the reader device is configured with dual-band frequency shift capabilities,
wherein the one or more processors are individually or collectively further operable to execute the code to cause the reader device to transmit the continuous wave in a downlink portion of a second frequency band that is lower in frequency relative to the first frequency band, and
wherein receive the backscattered signal comprises receiving the backscattered signal in an uplink portion of the second frequency band that is shifted, relative to the continuous wave in the downlink portion of the second frequency, by the frequency shift value.

3. The reader device of claim 2, wherein the first frequency band is 1800 MHz or 2100 MHz, the second frequency band is 900 MHz, and the frequency shift value is 45 MHz.

4. The reader device of claim 1, wherein the first frequency band supports a bandwidth greater than the frequency shift value or the first frequency band is an unlicensed frequency band.

5. The reader device of claim 1, wherein:
the reader device is configured with in-band frequency shift capabilities,
the first carrier wave or the second carrier wave comprises the continuous wave, and
the continuous wave is transmitted in a downlink portion of the first frequency band, and
wherein, to receive the backscattered signal, the one or more processors are individually or collectively operable to execute the code to cause the reader device to receive the backscattered signal in an uplink portion of the first frequency band that is shifted, relative to the continuous wave in the downlink portion of the first frequency band, by a multiple of a sum of the frequency shift value and the frequency of a local oscillator at the wireless device.

6. The reader device of claim 5, wherein the first frequency band is 900 MHz, the frequency shift value is 13.08 MHz, and the frequency of the local oscillator at the wireless device is 1.92 MHz.

7. The reader device of claim 5, wherein, to receive the backscattered signal, the one or more processors are individually or collectively operable to execute the code to cause the reader device to receive a third harmonic of a plurality of harmonics of the backscattered signal in the uplink portion of the first frequency band that is shifted, relative to the first carrier wave in the downlink portion of the first frequency band, by the multiple of the sum of the frequency shift value and the frequency of the local oscillator at the wireless device.

8. The reader device of claim 1, wherein the continuous wave comprises a multi-tone continuous wave.

9. The reader device of claim 1, wherein the reader device comprises a user equipment (UE) or a network entity.

10. A wireless device, comprising:
one or more memories storing processor-executable code; and
one or more processors coupled with the one or more memories and individually or collectively operable to execute the code to cause the wireless device to:
receive a first carrier wave at a first frequency within a first frequency band;
receive a second carrier wave at a second frequency within the first frequency band, wherein the first frequency and the second frequency are separated by a frequency shift value;
perform a nonlinear operation to obtain a frequency shift carrier wave that is based at least in part on a difference between the first frequency of the first carrier wave and the second frequency of the second carrier wave; and
send a signal backscattered on a continuous wave received at the wireless device, wherein the backscattered signal is sent at a frequency that is shifted, relative to a frequency at which the continuous wave is received, based at least in part on the frequency shift value.

11. The wireless device of claim 10, wherein the wireless device is configured with dual-band frequency shift capabilities, and
wherein the one or more processors are individually or collectively further operable to execute the code to cause the wireless device to:
receive the continuous wave in a downlink portion of a second frequency band that is lower in frequency relative to the first frequency band, and
send the backscattered signal in an uplink portion of the second frequency band that is shifted, relative to the continuous wave in the downlink portion of the second frequency, by the frequency shift value.

12. The wireless device of claim 11, wherein the first carrier wave and the second carrier wave are received at a first receive antenna of a first receive chain of the wireless device, wherein the first receive antenna is tuned to the first frequency band,
wherein the continuous wave is received at a second receive antenna of a second receive chain of the wireless device, wherein the second receive antenna is tuned to the second frequency band, and
wherein, to perform the nonlinear operation to obtain the frequency shift carrier wave, the one or more processors are individually or collectively operable to execute the code to cause the wireless device to perform the nonlinear operation using an envelope detector of the first receive chain.

13. The wireless device of claim 12, wherein the one or more processors are individually or collectively further operable to execute the code to cause the wireless device to:
receive, at a backscattering modulator of the wireless device, a square wave that is output by the first receive chain at the frequency shift value;
modulate, by the frequency shift value and data and at a backscattering antenna connected to the backscattering modulator, the continuous wave; and
generate, by the backscattering modulator, the backscattered signal as a product of the square wave and the modulated continuous wave, and
wherein, to send the backscattered signal, the one or more processors are individually or collectively operable to execute the code to cause the wireless device to send, from the backscattering antenna, the backscattered signal.

14. The wireless device of claim 13, wherein the one or more processors are individually or collectively further operable to execute the code to cause the wireless device to receive, at the backscattering modulator, a second frequency shift carrier wave that is output by a local oscillator at a second frequency shift value,
wherein, to generate the backscattered signal, the one or more processors are individually or collectively operable to execute the code to cause the wireless device to generate the backscattered signal based at least in part on the second frequency shift carrier wave, and
wherein, to send the backscattered signal, the one or more processors are individually or collectively operable to execute the code to cause the wireless device to send the backscattered signal at a frequency that is shifted, relative to the frequency at which the continuous wave is received, by a sum of the frequency shift value and the second frequency shift value.

15. The wireless device of claim 11, wherein the first frequency band is 1800 MHz or 2100 MHz, the second frequency band is 900 MHz, and the frequency shift value is 45 MHz.

16. The wireless device of claim 10, wherein the first frequency band supports a bandwidth greater than the frequency shift value or the first frequency band is an unlicensed frequency band.

17. The wireless device of claim 10, wherein:
the wireless device is configured with in-band frequency shift capabilities,
the first carrier wave or the second carrier wave comprises the continuous wave, and
the continuous wave is transmitted in a downlink portion of the first frequency band, and
wherein, to send the backscattered signal, the one or more processors are individually or collectively operable to execute the code to cause the wireless device to send the backscattered signal in an uplink portion of the first frequency band that is shifted, relative to the continuous wave in the downlink portion of the first frequency band, by a multiple of a sum of the frequency shift value and a frequency of a local oscillator.

18. The wireless device of claim 17, wherein the first frequency band is 900 MHz, and the frequency shift value is 13.08 MHz, and the frequency of the local oscillator at the wireless device is 1.92 MHz.

19. The wireless device of claim 17, wherein, to send the backscattered signal, the one or more processors are individually or collectively operable to execute the code to cause the wireless device to send the backscattered signal in the uplink portion of the first frequency band that is shifted, relative to the first carrier wave in the downlink portion of the first frequency band, by the multiple of the sum of the frequency shift value and the frequency of the local oscillator.

20. The wireless device of claim 10, wherein the continuous wave comprises a multi-tone continuous wave.

21. The wireless device of claim 10, wherein the wireless device comprises an Ambient Internet of Things (AIoT) device.

22. A method for wireless communications by a reader device, comprising:
transmitting, to a wireless device, a first carrier wave at a first frequency within a first frequency band;
transmitting, to the wireless device, a second carrier wave at a second frequency within the first frequency band, wherein the first frequency and the second frequency are separated by a frequency shift value; and
receiving, from the wireless device, a signal backscattered on a continuous wave transmitted to the wireless device, wherein the backscattered signal is received at a frequency that is shifted, relative to a frequency at which the continuous wave is transmitted, based at least in part on the frequency shift value.

23. The method of claim 22, wherein the reader device is configured with dual-band frequency shift capabilities,
wherein the method further comprises transmitting the continuous wave in a downlink portion of a second frequency band that is lower in frequency relative to the first frequency band, and
wherein receiving the backscattered signal comprises receiving the backscattered signal in an uplink portion of the second frequency band that is shifted, relative to the continuous wave in the downlink portion of the second frequency, by the frequency shift value.

24. The method of claim 22, wherein:
the reader device is configured with in-band frequency shift capabilities,
the first carrier wave or the second carrier wave comprises the continuous wave, and
the continuous wave is transmitted in a downlink portion of the first frequency band, and
wherein receiving the backscattered signal comprises receiving the backscattered signal in an uplink portion of the first frequency band that is shifted, relative to the continuous wave in the downlink portion of the first frequency band, by a multiple of a sum of the frequency shift value and a frequency of a local oscillator at the wireless device.

25. The method of claim 24, wherein receiving the backscattered signal comprises receiving a third harmonic of a plurality of harmonics of the backscattered signal in the uplink portion of the first frequency band that is shifted, relative to the first carrier wave in the downlink portion of the first frequency band, by the multiple of the sum of the frequency shift value and the frequency of the local oscillator at the wireless device.

26. A method for wireless communications by a wireless device, comprising:
receiving a first carrier wave at a first frequency within a first frequency band;
receiving a second carrier wave at a second frequency within the first frequency band, wherein the first frequency and the second frequency are separated by a frequency shift value;
performing a nonlinear operation to obtain a frequency shift carrier wave that is based at least in part on a difference between the first frequency of the first carrier wave and the second frequency of the second carrier wave; and
sending a signal backscattered on a continuous wave received at the wireless device, wherein the backscattered signal is sent at a frequency that is shifted, relative to a frequency at which the continuous wave is received, based at least in part on the frequency shift value.

27. The method of claim 26, wherein the wireless device is configured with dual-band frequency shift capabilities,
wherein the method further comprises receiving the continuous wave in a downlink portion of a second frequency band that is lower in frequency relative to the first frequency band, and
wherein sending the backscattered signal comprises sending the backscattered signal in an uplink portion of the second frequency band that is shifted, relative to the continuous wave in the downlink portion of the second frequency, by the frequency shift value.

28. The method of claim 27, wherein:
the first carrier wave and the second carrier wave are received at a first receive antenna of a first receive chain of the wireless device,
the first receive antenna is tuned to the first frequency band,
the continuous wave is received at a second receive antenna of a second receive chain of the wireless device, and
the second receive antenna is tuned to the second frequency band, and
wherein performing the nonlinear operation to obtain the frequency shift carrier wave comprises performing the nonlinear operation using an envelope detector of the first receive chain.

29. The method of claim 28, further comprising:
receiving, at a backscattering modulator of the wireless device, a square wave that is output by the first receive chain at the frequency shift value;
modulating, by the frequency shift value and data and at a backscattering antenna connected to the backscattering modulator, the continuous wave; and
generating, by the backscattering modulator, the backscattered signal as a product of the square wave and the modulated continuous wave,
wherein sending the backscattered signal comprises sending, from the backscattering antenna, the backscattered signal.

30. The method of claim 29, further comprising:
receiving, at the backscattering modulator, a second frequency shift carrier wave that is output by a local oscillator at a second frequency shift value, wherein generating the backscattered signal is based at least in part on the second frequency shift carrier wave,
wherein sending the backscattered signal comprises sending the backscattered signal at a frequency that is shifted, relative to the frequency at which the continuous wave is received, by a sum of the frequency shift value and the second frequency shift value.
